(19) United States
(12) Patent Application Publication
(10) Pub. No.: US 2010/0308664 A1
(43) Pub. Date: Dec. 9, 2010

(54) Lighting fixture with low voltage transformer and self-powered switching system

(76) Inventors: Bradbury R. Face, Norfolk, VA (US); Glenn F. Rogers, JR., Hampton, VA (US)

Correspondence Address: David J Bolduc;Face International Corporation, 427 West 35th Street, Norfolk, VA, 23508, US

(21) Appl. No.: 12/454,831

(22) Filed: May 22, 2009

(30) Foreign Application Priority Data
May 27, 2008 (US) PCT/US08/06679

(51) Int. Cl. H02J 17/00

(52) U.S. Cl. 307/104

(57) ABSTRACT

A self-powered switching system using electromechanical generators generates power for activation of a latching relay, switch, solenoid or latch pin. The electromechanical generators comprise electroactive elements that may be mechanically actuated to generate electrical power. The associated signal generation circuitry may be coupled to a transmitter for sending RF signals to a receiver which actuates the latching relay. The use of mechanically activated membrane switches on the deflector or on a keypad allows multiple code sequences to be generated for activating electrical appliances. The system also uses a communications protocol allowing the receivers to respond to signals from transmitters and/or repeaters. The use of one or more repeaters also increases the reliability of the system as well as extending its effective transmission range. The receivers use low DC voltage (which may be stepped down from the high switched voltage) to generate switching signals to control a low voltage controller for control of high or low voltage switching relays.

This application claims priority to PCT Application Serial No. PCT/US08/06679, filed on May 27, 2008, which claims the benefit of U.S. Provisional Patent Application Ser. No. 60/931,572 filed May 24, 2007 entitled “Lighting Fixture with Low Voltage Transformer & Self-Powered Switching System.

### BACKGROUND OF THE INVENTION

1. Field of the Invention

The present invention relates to light fixture having a transformed low voltage receptacle used for powering among other things an electronically coded switching system. More particularly, the present invention relates to a self-powered device that generates one or more activation signals for a low voltage switch. Electrical power in a wireless transmitter is generated by deforming a piezoelectric element while pressing the face plate or individual membrane switches on the face plate. When the face plate is depressed, the electrical power may then be used to power a RF transmitter to send one or more electronic codes to actuate a device or to perform some other command function. The system comprises one or more transmitters, receivers and repeaters that communicate specific electronic codes to each other to increase system range and reliability. The receiver is powered by a DC voltage under 60 VDC. This low voltage is acquired from a step-down transformer that transforms the switched AC voltage (or high DC voltage) to 12-24VDC. The low voltage receiver generates a low voltage DC switching signal that activates a relay to switch the high voltage switched power. The relay may have bifurcated outputs to allow switching of two or more electrical fixtures or sets of fixtures. The receiver may also operate in conjunction with one or more high or low voltage repeaters/transceivers as well as other devices such as security and motion sensors, fire alarms and emergency power activation and testing systems.

2. Description of the Prior Art

Switches and latching relays for energizing lights, appliances and the like are well known in the prior art. Typical light switches comprise, for example, single-pole switches and three-way switches. A single-pole switch has two terminals that are hot leads for an incoming line (power source) and an outgoing line to the light. Three-way switches can control one light from two different places. Each three-way switch has three terminals: the common terminal and two traveler terminals. A typical pair of three-way switches uses two boxes each having two cables with the first box having an incoming line from a power source and an outbound line to the second box, and the second box having the incoming line from the first box and an outbound line to the light.

In each of these switching schemes it is often necessary to drill holes and mount switches and junction boxes for the outlets as well as to run cable. Drilling holes and mounting switches and junction boxes can be difficult and time consuming. Also, running electrical cable requires starting at a fixture, pulling cable through holes in the framing to each fixture in the circuit, and continuing all the way back to the service panel. Though simple in theory, getting cable to cooperate can be difficult and time consuming. Cable often kinks, tangles or binds while pulling, and needs to be straightened out somewhere along the run.

Remotely actuated switches/relays are also known in the art. Known remote actuation controllers include tabletop controllers, wireless remotes, timers, motion detectors, voice activated controllers, and computers and related software. For example, remote actuation means may include receiver modules that are plugged into a wall outlet and into which a power cord for a device may be plugged. The device can then be turned on and off by a remote controller/transmitter. Other remote actuation means include screw-in lamp receiver modules wherein the receiver module is screwed into a light socket, and then a bulb screwed into the receiver module. The light can be turned on and off and can be dimmed or brightened by a remote controller/transmitter.

Another example of one type of remote controller for the above described modules is a radio frequency (RF) base transceiver. With these controllers, a transceiver base is plugged into an outlet and can control groups of receiver modules in conjunction with a hand held wireless RF remote. RF repeaters may be used to boost the range of compatible wireless remote transmitters, switches and security system sensors by up to 150 ft. per repeater. The transceiver base is required for these wireless RF remote control systems and allows control of several lamps or appliances. Batteries are also required in the hand held wireless remote control systems.

Rather than using a hand held RF remote transmitter, remote wall transmitters may be used. These wall transmitters, which are up to ¾″ thick, are affixed to a desired location with an adhesive or fastener. In conjunction with a transceiver base unit (plugged into a 110V receptacle) the remote wall transmitter may control compatible receiver/transceiver modules and their associated switches. The wireless transmitters send an RF signal to the transceiver base unit and the transceiver base unit then transmits a signal along the existing 110V wiring in the home to compatible switches or receiver modules. Each switch can be programmed with an addressable signal. These wireless transmitters also require batteries.

These remotes control devices may also control, for example, audio/video devices such as the TV, VCR, and stereo system, as well as lights and other devices using an RF to infrared (IR) base. The RF remote can control audio/video devices by sending proprietary RF commands to a converter that translates the commands to IR. IR commands are then sent to the audio/video equipment. The infrared (IR) base responds to infrared signals from the infrared remotes and then transmits equivalent commands to compatible receivers.

A problem with conventional wall switches is that extensive wiring must be run both from the switch boxes to the lights and from the switch boxes to the power source in the service panels.

Another problem with conventional wall switches is that additional wiring must be run for lights controlled by more than one switch.

Another problem with conventional wall switches is that the voltage lines are present as an input to and an output from the switch.

Another problem with conventional wall switches is the cost associated with initial installation of wire to, from and between switches.

Another problem with conventional wall switches is the cost and inconvenience associated with remodeling, relocating or rewiring existing switches.

A problem with conventional RF transmitters is that they require an external power source such as high voltage AC power or batteries.

Another problem with conventional battery-powered RF transmitters is the cost and inconvenience associated with replacement of batteries.

Another problem with conventional AC-powered RF transmitters is the difficulty when remodeling in rewiring or relocating a wall transmitter.

Another problem with conventional RF switching systems is that a pair comprising a transmitter and receiver must generally be purchased together.

Another problem with conventional RF switching systems is that transmitters may inadvertently activate incorrect receivers.

Another problem with conventional RF switching systems is that receivers may accept an activation signal from only one transmitter.

Another problem with conventional RF switching systems is that transmitters may activate only one receiver.

Another problem with conventional RF switching systems is that multiple signals from transmitters and/or repeaters may inadvertently activate or deactivate a receiver switching mechanism.

Another problem with conventional RF switching systems is that receivers may have their reception blocked by building obstacles.

Another problem with conventional RF switching systems is that multiple types of receivers are necessary depending on the type of input voltage that is available.

Another problem with conventional RF switching systems is that receivers are not isolated from the voltage passed through the relay they control.

Accordingly, it would be desirable to provide a network of transmitters, receivers, repeaters, switch initiators, and/or latching relay devices that overcomes the aforementioned problems of the prior art.

### SUMMARY OF THE INVENTION

The present invention provides a self-powered electronically coded switching system or device using an electroactive transducer. The piezoelectric element in the electroactive transducer is capable of deforming with a high amount of axial displacement, and when deformed by a mechanical impulse generates an electric field. The electroactive transducer is used as an electromechanical generator for generating an electrical signal that actuates a switch, actuator relay and/or locking mechanism. The electroactive transducer is used as an electromechanical converter/generator for generating an electrical signal that, with the accompanying circuitry, generates an RF signal that initiates a latching or relay mechanism. The latching or relay mechanism thereby turns electrical devices such as lights and appliances on and off or provides an intermediate or dimming signal, or initiates other functions.

A receiver controls the relay or other switching device. Preferably the receiver is located within/on a lighting fixture adapted to receive and retain the receiver. The fixture has a step down transformer therein for transforming the line voltage, e.g., 120 or 277 VAC to a low DC voltage, e.g., 12-24 VDC for powering the receiver and/or other devices. The receiver is programmable to perform many different command functions for controlling a variety of electrical devices such as lights, sensors, fan motors, emergency lighting or the like. The receiver, therefore, may have multiple connection points, in order to provide the correct logic output to the controlled devices. Alternately, the lighting fixture may have multiple low voltage connection points for control of those devices either through an already established wiring system, or for wireless control through the receiver. The fixture may also have a battery therein for providing emergency power to lighting, sensors, alarms and the like. The emergency power/battery testing is controllable wirelessly by the receiver.

Co-owned U.S. Pat. No. 6,630,894 entitled “Self-Powered Switching Device,” which is hereby incorporated by reference, discloses a self-powered switch where the electroactive element generates an electrical pulse. Co-owned U.S. Pat. No. 6,812,594 entitled “Self-Powered Trainable Switching Network,” which is hereby incorporated by reference, discloses a network of switches such as that disclosed in U.S. Pat. No. 6,630,894, with the modification that the switches and receivers are capable accepting a multiplicity of coded RF signals. Co-owned U.S. Pat. No. 7,084,529 entitled “Self-Powered Switch Initiation System,” which is hereby incorporated by reference, discloses a network of switches such as that disclosed in U.S. Pat. Nos. 6,630,894 and 6,812,594, with additional modifications to the coded RF signals, multiple training topologies, and an improved mounting and actuation means, as well as circuitry to support the output electrical signal of the transducer. Co-owned U.S. Pat. No. 7,126,497 entitled “Self-Powered Switch Initiation System,” which is hereby incorporated by reference, discloses a network of switches such as that disclosed in U.S. Pat. Nos. 6,630,894 and 6,812,594, with additional modifications to the actuation mechanism, and further incorporating rechargeable batteries for the receiver, transmitter and/or transceivers. Co-owned U.S. Pat. No. 7,161,276 entitled “Self-Powered, Electronic Keyed Multifunction Switching System,” which is hereby incorporated by reference, discloses a network of switches such as that disclosed in U.S. Pat. Nos. 6,630,894 and 6,812,594, with additional modifications that the transmitters incorporate membrane switches for multiple function codes.

The mechanical actuating means for the electroactive generator element applies a suitable mechanical impulse to the electroactive generator element in order to generate an electrical signal, such as a pulse, multiple pulses and/or waves having sufficient magnitude and duration to power and actuate downstream circuit components. A mechanism similar to a light switch or pressure switch, for example, may apply pressure through a toggle, snap action, paddle, plunger, plucking and/or ratchet mechanism. Larger or multiple electroactive generator elements may also be used to generate the electrical signal.

In the present invention a self-powered switch initiation system uses an electroactive element to develop an oscillating electrical signal. The accompanying circuitry is designed to work with that signal and generate a coded RF transmission. The codes are preferably a 32-bit binary code comprising a unique (i.e., one of 2²⁴ to 2³⁰ combinations) transmitter identification code and a function code. To further enhance the system, the system uses a repeater/transceiver system to increase transmission range and reliability of receipt of transmitted signals. The codes sent by the transmitter are modified and rebroadcast by the repeater(s). The response action by the receiver and repeaters to codes either from a transmitter or another repeater depends on the nature of the received code. The nature of the information contained in the code e.g., identification, function and source, is further described. Repeaters also use a poling/initialization routine to assign times slots to each repeater to prevent interference between repeaters.

In one embodiment of the invention, the electroactive generator output signal powers an RF transmitter which sends an RF signal to an RF receiver which then actuates the relay. In yet another embodiment, the electromagnetic or electroactive generator output signal powers a transmitter, which sends a pulsed (coded) RF signal to an RF receiver which then actuates the relay. Digitized RF signals are coded (as with a garage door opener) to only activate the relay that is trained to receive that digitized coded RF signal. The transmitters may be capable of developing one or more coded RF signals and the receivers likewise are capable of receiving one or more coded RF signals. Furthermore, the receivers may be “trainable” to accept coded RF signals from new or multiple transmitters and repeaters. In another embodiment of the invention, rechargeable batteries are used to capture some of the electrical output of the generator and apply the stored energy to circuit components. In another embodiment of the invention uses a transceiver/repeater and transmission circuit to receive and retransmit RF signals within the system.

In the preferred embodiment, the receiver is powered by a low DC voltage, e.g., 12-24 VDC, and sends a low voltage actuation signal to a relay controller. The low voltage is obtained via a power pack and/or transformer that steps down the switched voltage, e.g., 120 or 277 VAC, to the low voltage. This transformer is preferably located in the light fixture, and provides low voltage outputs to one or more devices, including outputs for a low voltage receiver, a sensor, a light, an alarm, emergency lighting or the like. The receiver generates a low voltage actuation signal activates the relay that switches the high switched voltage. The receiver may also generate a low voltage activation signal for actuating or testing the low voltage sensor, a light, an alarm, emergency lighting or the like. The low voltage transformer may also supply a battery for emergency power to alarms, sensors, emergency lighting and other health and safety devices. Testing or operation of these health and safety devices can be activated from the receiver.

Preferably the receiver has an output of at least three activation signals corresponding to “ALL OFF”, “ALL ON”, and “HALF ON” which signals are directed through one or more relay controllers to the bifurcated/three-way output(s) of the switched relay. Alternately, the receiver may have multiple output ports, which are selectable dependent upon the device to be controlled. The receiver is programmable to control multiple devices, i.e., the receiver is programmed to control many different devices, and the programming varies dependent upon the operating mode of the device to be controlled. Each of the output ports of the receiver has access to different programs/operating modes within the receiver. Therefor, attaching a device to defined output ports allows those devices to be controlled with the appropriate programming/control modes from a single receiver.

Accordingly, it is a primary object of the present invention to provide a switching system in which an electroactive or piezoelectric element is used to power an RF transmitter for activating an electrical device.

It is another object of the present invention to provide a device of the character described in which transmitters may be installed without necessitating additional wiring.

It is another object of the present invention to provide a device of the character described in which transmitters may be installed without cutting holes into the building structure.

It is another object of the present invention to provide a device of the character described in which transmitters do not require external electrical input such as 120 or 220VAC or batteries.

It is another object of the present invention to provide a device of the character described incorporating an electroactive converter that generates an electrical signal of sufficient duration and magnitude to power a radio frequency transmitter for activating a latching relay and/or switch initiator.

It is another object of the present invention to provide a device of the character described incorporating a transmitter that is capable of developing at least one coded RF signal.

It is another object of the present invention to provide a device of the character described incorporating a receiver capable of receiving at least one coded RF signal from at least one transmitter.

It is another object of the present invention to provide a device of the character described incorporating a receiver capable of “learning” to accept coded RF signals from one or more transmitters.

It is another object of the present invention to provide a device of the character described for use in actuating multiple command functions for electrical devices and other fixtures in a building.

It is another object of the present invention to provide a device of the character described which uses a repeater system for extending the range of transmission and reception reliability between transmitters and receivers.

It is another object of the present invention to provide a device of the character described in which a power pack is used to provide low voltage DC power to a receiver.

It is another object of the present invention to provide a device of the character described in which a low voltage output transformer built into a light fixture is used to provide low voltage DC power to multiple devices, including a receiver, repeater, sensor, alarm, battery or emergency lighting.

It is another object of the present invention to provide a device of the character described in which a low voltage DC receiver is used to provide a low voltage DC signal to a relay controller within a power pack.

It is another object of the present invention to provide a device of the character described in which low voltage DC receiver is used to provide one or more low voltage DC signals to one or more relay controllers for providing two or more switching options.

It is another object of the present invention to provide a device of the character described in which low voltage DC receiver is used to provide one or more low voltage DC signals to one or more relay controllers for providing two or more switching options.

It is another object of the present invention to provide a device of the character described in which a low voltage DC powered receiver has multiple outputs for control of multiple DC powered devices including a sensor, alarm, lighting, battery or emergency lighting.

It is another object of the present invention to provide a device of the character described in which a lighting fixture includes a low voltage transformer as well as retention means for a low voltage receiver.

Further objects and advantages of the invention will become apparent from a consideration of the drawings and ensuing description thereof.

### BRIEF DESCRIPTION OF THE DRAWINGS

FIG. 1 is an elevation view showing the details of construction of a flextensional piezoelectric transducer used in the present invention, as an electroactive generator;

FIG. 1a is an elevation view showing the details of construction of the flextensional piezoelectric generator of FIG. 1 having an additional prestress layer;

FIG. 2 is an elevation view showing the details of construction of an alternate multi-layer flextensional piezoelectric generator used in a modification of the present invention;

FIG. 2a is an elevation view showing the details of construction of the flextensional piezoelectric generator of FIG. 1a with a flat rather than arcuate profile;

FIG. 3 is an elevation view showing the details of construction of an alternate multi-layer flextensional piezoelectric actuator used in a modification the present invention;

FIG. 4 is an elevation view of the device of FIGS. 1, 1a, 2 and 3 (with an attached end-mass) in the preferred mounting device;

FIG. 5 is an elevation view of the device of FIG. 4 (without the attached end-mass) illustrating the deformation and recovery of the electroactive generator;

FIG. 6 is an elevation view of an alternate mounting and actuating device of the present invention for generation of an electrical signal by deflecting a flextensional piezoelectric transducer of FIG. 2a;

FIGS. 7a-7c show an alternate clamping mechanism for retention of an end of a flextensional piezoelectric transducer in undeflected and deflected states;

FIG. 8 is a plan view of a domed contact switch showing disconnected concentric circuit traces, with the domed contact in ghost thereabove;

FIG. 9 is a plane view of a contact switch showing disconnected interdigitated circuit traces, with the shorting contact in ghost thereabove;

FIGS. 10a-a-c show the electrical signal generated by the transducer, the electrical output signal of the rectifier at the junction with the capacitor and the regulated electrical signal respectively;

FIGS. 11a and 11b are elevation views of the preferred deflector assembly of the present invention showing the transducer in the undeflected and deflected positions respectively;

FIG. 11c is a plan view of the preferred deflector assembly of the present invention showing the transducer in the undeflected position;

FIGS. 12a-a-e are elevation views of one embodiment of a plucker paddle mechanism as in FIGS. 11a-a-c, deflecting the end of an electroactive generator, and rotating/cocking to a reset position;

FIG. 13 is a plan view of a face plate and switch housing having two membrane switches thereon for direct connection to a transmitter circuit to provide separate functions;

FIG. 14 is a plan view of the face plate and switch housing of FIG. 13 showing a deflection assembly and piezoelectric generator in ghost therein;

FIG. 15 is a block diagram showing the components of a device for using the electrical signal generated by the device of FIGS. 11a-a-c and 13-14 to activate a transmitter for sending one or more coded signals to activate a switching device;

FIG. 16 is a block diagram of a repeater for receiving transmitted and repeated codes and sending a coded signal to a receiver;

FIG. 17 is a block diagram showing the components of a circuit for using the electrical signal generated by the device of FIGS. 6-8, and 11-16;

FIG. 18 is a block diagram showing the components of an alternate circuit for using the electrical signal generated by the device of FIGS. 6-8, and 11-16 with a rechargeable battery and transceivers;

FIG. 19 is a detailed circuit diagram of the circuit in FIG. 17;

FIG. 20 is a detailed circuit diagram of the circuit in FIG. 18;

FIG. 21 is a detailed circuit diagram of an alternate circuit in FIG. 18;

FIG. 22 is a schematic showing the transmitted code and repeated code and handshake code and their components;

FIG. 23 is a schematic showing the transmission, repetition and reception between the transmitter, receiver and multiple repeaters;

FIG. 24 is a schematic showing the power pack, relay and low voltage controller in mounted adjacent to the controlled overhead fixture and low voltage receiver connected thereto with wires;

FIG. 25 is a schematic showing the power pack, relay and low voltage receiver/controller (unitarily) mounted adjacent to the controlled overhead fixture with a separate system extender;

FIG. 26 is a schematic showing the power pack (interchangeable), relay and low voltage controller mounted adjacent to the controlled overhead fixture and low voltage two-output (bifurcated) receiver connected thereto with wires;

FIG. 27 is a partial schematic wiring diagram showing the power pack, relays and low voltage controller mounted adjacent to the controlled overhead fixture and low voltage two-output (bifurcated) receiver of FIG. 26;

FIG. 28 is a block diagram showing a lighting fixture with a low voltage transformer having multiple outputs for various devices including a receiver within a receiver receptacle; and

FIG. 29 is a block diagram showing a lighting fixture with a low voltage transformer and a receiver within a receiver receptacle having multiple outputs for various devices.

### DESCRIPTION OF THE PREFERRED EMBODIMENT

### Electroactive Generator

Piezoelectric and electrostrictive materials (generally called “electroactive” devices herein) develop an electric field when placed under stress or strain. The electric field developed by a piezoelectric or electrostrictive material is a function of the applied force and displacement causing the mechanical stress or strain. Conversely, electroactive devices undergo dimensional changes in an applied electric field. The dimensional change (i.e., expansion or contraction) of an electroactive element is a function of the applied electric field. Electroactive devices are commonly used as drivers, or “actuators” due to their propensity to deform under such electric fields. These electroactive devices when used as transducers or generators also have varying capacities to generate an electric field in response to a deformation caused by an applied force. In such cases they behave as electrical generators.

Electroactive devices include direct and indirect mode actuators, which typically make use of a change in the dimensions of the material to achieve a displacement, but in the present invention are preferably used as electromechanical generators. Direct mode actuators typically include a piezoelectric or electrostrictive ceramic plate (or stack of plates) sandwiched between a pair of electrodes formed on its major surfaces. The devices generally have a sufficiently large piezoelectric and/or electrostrictive coefficient to produce the desired strain in the ceramic plate. However, direct mode actuators suffer from the disadvantage of only being able to achieve a very small displacement (strain), which is, at best, only a few tenths of a percent. Conversely, direct mode generator-actuators require application of a high amount of force to piezoelectrically generate a pulsed momentary electrical signal of sufficient magnitude to activate a latching relay.

Indirect mode actuators are known to exhibit greater displacement and strain than is achievable with direct mode actuators by achieving strain amplification via external structures. An example of an indirect mode actuator is a flextensional transducer.

Flextensional transducers are composite structures composed of a piezoelectric ceramic element and a metallic shell, stressed plastic, fiberglass, or similar structures. The actuator movement of conventional flextensional devices commonly occurs as a result of expansion in the piezoelectric material which mechanically couples to an amplified contraction of the device in the transverse direction. In operation, they can exhibit several orders of magnitude greater strain and displacement than can be produced by direct mode actuators.

The magnitude of achievable deflection (transverse bending) of indirect mode actuators can be increased by constructing them either as “unimorph” or “bimorph” flextensional actuators. A typical unimorph is a concave structure composed of a single piezoelectric element externally bonded to a flexible metal foil, and which results in axial buckling (deflection normal to the plane of the electroactive element) when electrically energized. Common unimorphs can exhibit transverse bending as high as 10%, i.e., a deflection normal to the plane of the element equal to 10% of the length of the actuator. A conventional bimorph device includes an intermediate flexible metal foil sandwiched between two piezoelectric elements. Electrodes are bonded to each of the major surfaces of the ceramic elements and the metal foil is bonded to the inner two electrodes. Bimorphs exhibit more displacement than comparable unimorphs because under the applied voltage, one ceramic element will contract while the other expands. Bimorphs can exhibit transverse bending of up to 20% of the Bimorph length.

For certain applications, asymmetrically stress biased electroactive devices have been proposed in order to increase the transverse bending of the electroactive generator, and therefore increase the electrical output in the electroactive material. In such devices, (which include, for example, “Rainbow” actuators (as disclosed in U.S. Pat. No. 5,471,721), and other flextensional actuators) the asymmetric stress biasing produces a curved structure, typically having two major surfaces, one of which is concave and the other which is convex.

Thus, various constructions of flextensional piezoelectric and ferroelectric generators may be used including: indirect mode actuators (such as “moonies” and, CYMBAL); bending actuators (such as unimorph, bimorph, multimorph or monomorph devices); prestressed actuators (such as “THUNDER” and rainbow” actuators as disclosed in U.S. Pat. No. 5,471,721); and multilayer actuators such as stacked actuators; and polymer piezofilms such as PVDF. Many other electromechanical devices exist and are contemplated to function similarly to power a transceiver circuit in the invention.

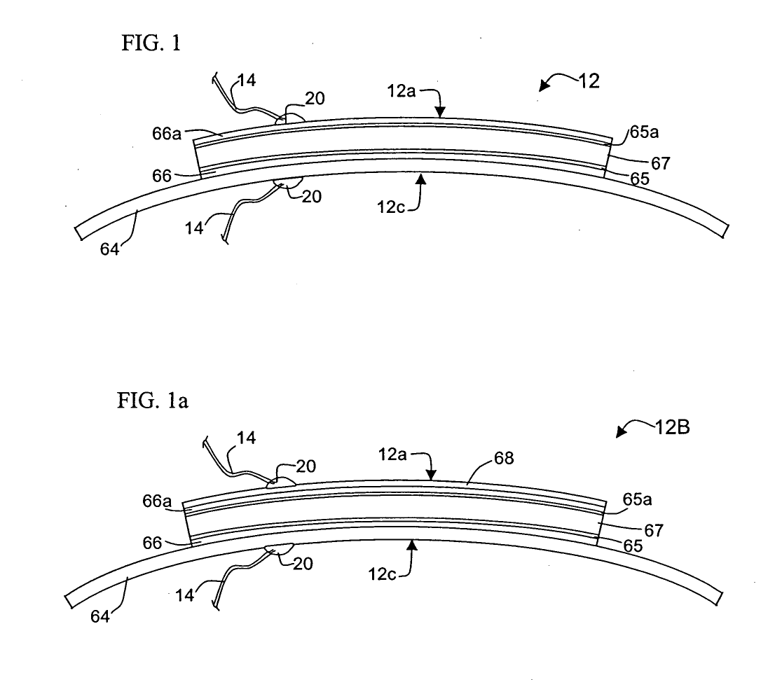

Referring to FIG. 1: The electroactive generator preferably comprises a prestressed unimorph device called “THUNDER”, which has improved displacement and load capabilities, as disclosed in U.S. Pat. No. 5,632,841. THUNDER (which is an acronym for THin layer composite UNimorph ferroelectric Driver and sEnsoR), is a unimorph device in which a pre-stress layer is bonded to a thin piezoelectric ceramic wafer at high temperature. During the cooling down of the composite structure, asymmetrical stress biases the ceramic wafer due to the difference in thermal contraction rates of the pre-stress layer and the ceramic layer. A THUNDER element comprises a piezoelectric ceramic layer bonded with an adhesive (preferably an imide) to a metal (preferably stainless steel) substrate. The substrate, ceramic and adhesive are heated until the adhesive melts and they are subsequently cooled. During cooling as the adhesive solidifies the adhesive and substrate thermally contracts more than the ceramic, which compressively stresses the ceramic. Using a single substrate, or two substrates with differing thermal and mechanical characteristics, the actuator assumes its normally arcuate shape. The transducer or electroactive generator may also be normally flat rather than arcuate, by applying equal amounts of prestress to each side of the piezoelectric element, as dictated by the thermal and mechanical characteristics of the substrates bonded to each face of the piezo-element.

The THUNDER element 12 is as a composite structure, the construction of which is illustrated in FIG. 1. Each THUNDER element 12 is constructed with an electroactive member preferably comprising a piezoelectric ceramic layer 67 of PZT which is electroplated 65 and 65a on its two opposing faces. A pre-stress layer 64, preferably comprising spring steel, stainless steel, beryllium alloy, aluminum or other flexible substrate (such as metal, fiberglass, carbon fiber, KEVLAR™, composites or plastic), is adhered to the electroplated 65 surface on one side of the ceramic layer 67 by a first adhesive layer 66. In the simplest embodiment, the adhesive layer 66 acts as a prestress layer. The first adhesive layer 66 is preferably LaRC™-SI material, as developed by NASA-Langley Research Center and disclosed in U.S. Pat. No. 5,639,850. A second adhesive layer 66a, also preferably comprising LaRC-SI material, is adhered to the opposite side of the ceramic layer 67. During manufacture of the THUNDER element 12 the ceramic layer 67, the adhesive layer(s) 66 and 66a and the pre-stress layer 64 are simultaneously heated to a temperature above the melting point of the adhesive material. In practice the various layers composing the THUNDER element (namely the ceramic layer 67, the adhesive layers 66 and 66a and the pre-stress layer 64) are typically placed inside of an autoclave, heated platen press or a convection oven as a composite structure, and slowly heated under pressure by convection until all the layers of the structure reach a temperature which is above the melting point of the adhesive 66 material but below the Curie temperature of the ceramic layer 67. Because the composite structure is typically convectively heated at a slow rate, all of the layers tend to be at approximately the same temperature. In any event, because an adhesive layer 66 is typically located between two other layers (i.e. between the ceramic layer 67 and the pre-stress layer 64), the ceramic layer 67 and the pre-stress layer 64 are usually very close to the same temperature and are at least as hot as the adhesive layers 66 and 66a during the heating step of the process. The THUNDER element 12 is then allowed to cool.

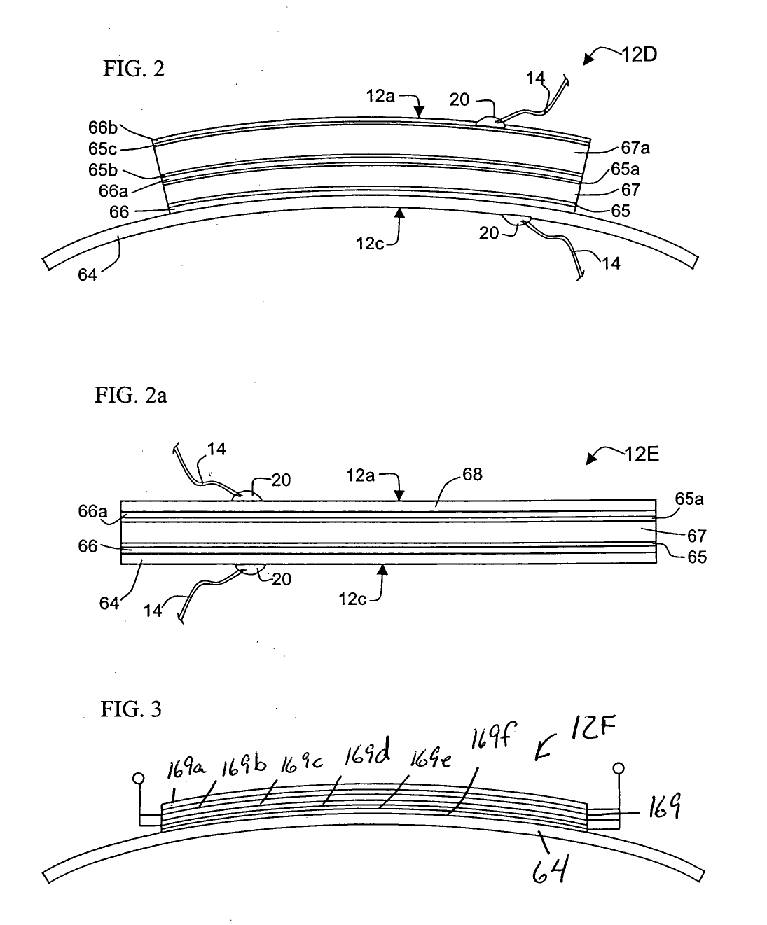

During the cooling step of the process (i.e. after the adhesive layers 66 and 66a have re-solidified) the ceramic layer 67 becomes compressively stressed by the adhesive layers 66 and 66a and pre-stress layer 64 due to the higher coefficient of thermal contraction of the materials of the adhesive layers 66 and 66a and the pre-stress layer 64 than for the material of the ceramic layer 67. Also, due to the greater thermal contraction of the laminate materials (e.g. the first pre-stress layer 64 and the first adhesive layer 66) on one side of the ceramic layer 67 relative to the thermal contraction of the laminate material(s) (e.g. the second adhesive layer 66a) on the other side of the ceramic layer 67, the ceramic layer deforms in an arcuate shape having a normally convex face 12a and a normally concave face 12c, as illustrated in FIGS. 1 and 2.

Referring to FIG. 1a: One or more additional pre-stressing layer(s) may be similarly adhered to either or both sides of the ceramic layer 67 in order, for example, to increase the stress in the ceramic layer 67 or to strengthen the THUNDER element 12B. In a preferred embodiment of the invention, a second prestress layer 68 is placed on the concave face 12a of the THUNDER element 12B having the second adhesive layer 66a and is similarly heated and cooled. Preferably the second prestress layer 68 comprises a layer of conductive metal. More preferably the second prestress layer 68 comprises a thin foil (relatively thinner than the first prestress layer 64) comprising aluminum or other conductive metal. During the cooling step of the process (i.e. after the adhesive layers 66 and 66a have re-solidified) the ceramic layer 67 similarly becomes compressively stressed by the adhesive layers 66 and 66a and pre-stress layers 64 and 68 due to the higher coefficient of thermal contraction of the materials of the adhesive layers 66 and 66a and the pre-stress layers 64 and 68 than for the material of the ceramic layer 67. Also, due to the greater thermal contraction of the laminate materials (e.g. the first pre-stress layer 64 and the first adhesive layer 66) on one side of the ceramic layer 67 relative to the thermal contraction of the laminate material(s) (e.g. the second adhesive layer 66a and the second prestress layer 68) on the other side of the ceramic layer 67, the ceramic layer 67 deforms into an arcuate shape having a normally convex face 12a and a normally concave face 12c, as illustrated in FIG. 1a.

Alternately, the second prestress layer 68 may comprise the same material as is used in the first prestress layer 64, or a material with substantially the same mechanical strain characteristics. Using two prestress layers 64, 68 having similar mechanical strain characteristics ensures that, upon cooling, the thermal contraction of the laminate materials (e.g. the first pre-stress layer 64 and the first adhesive layer 66,) on one side of the ceramic layer 67 is substantially equal to the thermal contraction of the laminate materials (e.g. the second adhesive layer 66a and the second prestress layer 68) on the other side of the ceramic layer 67, and the ceramic layer 67 and the transducer 12 remain substantially flat, but still under a compressive stress.

Alternatively, the substrate comprising a separate prestress layer 64 may be eliminated and the adhesive layers 66 and 66a alone or in conjunction may apply the prestress to the ceramic layer 67. Alternatively, only the prestress layer(s) 64 and 68 and the adhesive layer(s) 66 and 66a may be heated and bonded to a ceramic layer 67, while the ceramic layer 67 is at a lower temperature, in order to induce greater compressive stress into the ceramic layer 67 when cooling the transducer 12.

Referring now to FIG. 2: Yet another alternate THUNDER generator element 12D includes a composite piezoelectric ceramic layer 69 that comprises multiple thin layers 69a and 69b of PZT which are bonded to each other or cofired together. In the mechanically bonded embodiment of FIG. 2, two layers 69a and 69b, or more (not shown) may be used in this composite structure 12D. Each layer 69a and 69b comprises a thin layer of piezoelectric material, with a thickness preferably on the order of about 1 mil. Each thin layer 69a and 69b is electroplated 65 and 65a, and 65b and 65c on each major face respectively. The individual layers 69a and 69b are then bonded to each other with an adhesive layer 66b, using an adhesive such as LaRC-SI. Alternatively, and most preferably, the thin layers 69a and 69b may be bonded to each other by cofiring the thin sheets of piezoelectric material together. As few as two layers 69a and 69b, but preferably at least four thin sheets of piezoelectric material may be bonded/cofired together. The composite piezoelectric ceramic layer 69 may then be bonded to prestress layer(s) 64 with the adhesive layer(s) 66 and 66a, and heated and cooled as described above to make a modified THUNDER transducer 12D. By having multiple thinner layers 69a and 69b of piezoelectric material in a modified transducer 12D, the composite ceramic layer generates a lower voltage and higher current as compared to the high voltage and low current generated by a THUNDER transducer 12 having only a single thicker ceramic layer 67. Additionally, a second prestress layer may be used comprise the same material as is used in the first prestress layer 64, or a material with substantially the same mechanical strain characteristics as described above, so that the composite piezoelectric ceramic layer 69 and the transducer 12D remain substantially flat, but still under a compressive stress.

Referring now to FIG. 3: Yet another alternate THUNDER generator element 12F includes another composite piezoelectric ceramic layer 169 that comprises multiple thin layers 169a-f of PZT which are cofired together. In the cofired embodiment of FIG. 3, two or more layers 169a-f, and preferably at least four layers, are used in this composite structure 12F. Each layer 169a-f comprises a thin layer of piezoelectric material, with a thickness preferably on the order of about 1 mil, which are manufactured using thin tape casting for example. Each thin layer 169a-f placed adjacent each other with electrode material between each successive layer. The electrode material may include metallizations, screen printed, electro-deposited, sputtered, and/or vapor deposited conductive materials. The individual layers 169a-f and internal electrodes are then bonded to each other by cofiring the composite multi-layer ceramic element 169. The individual layers 169a-f are then poled in alternating directions in the thickness direction. This is accomplished by connecting high voltage electrical connections to the electrodes, wherein positive connections are connected to alternate electrodes, and ground connections are connected to the remaining internal electrodes. This provides an alternating up-down polarization of the layers 169a-f in the thickness direction. This allows all the individual ceramic layers 169a-f to be connected in parallel. The composite piezoelectric ceramic layer 169 may then be bonded to prestress layer(s) 64 with the adhesive layer(s) 66 and 66a, and heated and cooled as described above to make a modified THUNDER transducer 12D.

Referring again to FIGS. 2, 2a and 3: By having multiple thinner layers 69a and 69b (or 169a-f) of piezoelectric material in a modified transducer 12D-F, the composite ceramic layer generates a lower voltage and higher current as compared to the high voltage and low current generated by a THUNDER transducer 12 having only a single thicker ceramic layer 67. This is because with multiple thin paralleled layers the output capacitance is increased, which decreases the output impedance, which provides better impedance matching with the electronic circuitry connected to the THUNDER element. Also, since the individual layers of the composite element are thinner, the output voltage can be reduced to reach a voltage which is closer to the operating voltage of the electronic circuitry (in a range of 3.3V-10.0V) which provides less waste in the regulation of the voltage and better matching to the desired operating voltages of the circuit. Thus the multilayer element (bonded or cofired) improves impedance matching with the connected electronic circuitry and improves the efficiency of the mechanical to electrical conversion of the element.

A flexible insulator may be used to coat the convex face 12a of the transducer 12.

This insulative coating helps prevent unintentional discharge of the piezoelectric element through inadvertent contact with another conductor, liquid or human contact. The coating also makes the ceramic element more durable and resistant to cracking or damage from impact. Since LaRC-SI is a dielectric, the adhesive layer 67a on the convex face 12a of the transducer 12 may act as the insulative layer. Alternately, the insulative layer may comprise a plastic, TEFLON or other durable coating.

Electrical energy may be recovered from or introduced to the generator element 12 (or 12D) by a pair of electrical wires 14. Each electrical wire 14 is attached at one end to opposite sides of the generator element 12. The wires 14 may be connected directly to the electroplated 65 and 65a faces of the ceramic layer 67, or they may alternatively be connected to the pre-stress layer(s) 64 and or 68. The wires 14 are connected using, for example, conductive adhesive, or solder 20, but most preferably a conductive tape, such as a copper foil tape adhesively placed on the faces of the electroactive generator element, thus avoiding the soldering or gluing of the conductor. As discussed above, the pre-stress layer 64 is preferably adhered to the ceramic layer 67 by LaRC-SI material, which is a dielectric. When the wires 14 are connected to the pre-stress layer(s) 64 and/or 68, it is desirable to roughen a face of the pre-stress layer 68, so that the pre-stress layer 68 intermittently penetrates the respective adhesive layers 66 and 66a, and makes electrical contact with the respective electroplated 65 and 65a faces of the ceramic layer 67. Alternatively, the Lam-SI adhesive layer 66 may have a conductive material, such as Nickel or aluminum particles, used as a filler in the adhesive and to maintain electrical contact between the prestress layer and the electroplated faces of the ceramic layer(s). The opposite end of each electrical wire 14 is preferably connected to an electric pulse modification circuit 10.

Prestressed flextensional transducers 12 are desirable due to their durability and their relatively large displacement, and concomitant relatively high voltage that such transducers are capable of developing when deflected by an external force. The present invention however may be practiced with any electroactive element having the properties and characteristics herein described, i.e., the ability to generate a voltage in response to a deformation of the device. For example, the invention may be practiced using magnetostrictive or ferroelectric devices. The transducers also need not be normally arcuate, but may also include transducers that are normally flat, and may further include stacked piezoelectric elements.

Although in the preferred embodiment of the invention, the electro-mechanical generator comprises a THUNDER actuator 12 or other electroactive element, it is within the scope of the invention to include other types of electromechanical generators. For example. The electromechanical generator may comprise a series of coils and one or more magnets. When the buttons of the keypad are pressed the coils and magnets have motion relative to each other, and this induces a current in the coils.

### Mechanical Deflector

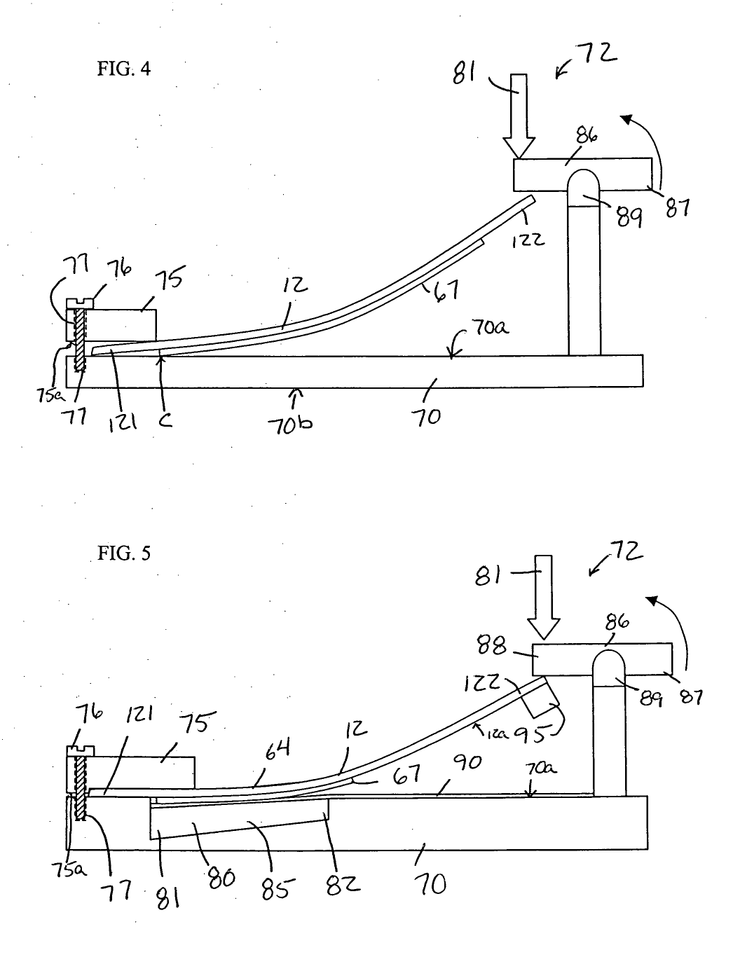

In operation, when a force is applied to a face 12a or 12c of the actuator 12, the force deforms the piezoelectric element 67. The force may be applied to the piezoelectric actuator 12 by any appropriate means such as by application of manual pressure directly to the piezoelectric actuator 12, or by other mechanical means. The force may also be applied to an edge of the actuator 12. More specifically, the actuator 12 has first and second ends 121, 122. One of the ends 121 is preferably in a fixed, i.e., non-moveable position via appropriate fixation means such as clamps and/or screws. The opposite end, or free end 122 may be deflected by appropriate deflection means. The mechanical impulse (or removal thereof) is of sufficient force to cause the actuator 12 to deform quickly and accelerate over a distance (approximately 1-5 mm) which generates an electrical signal of sufficient magnitude to activate an electronic circuit. In the embodiments of the invention in FIGS. 4-8, pressure is applied directly to the actuator 12 by pushing on (mechanically activating) the membrane switches, electronic keypad and/or faceplate.

A description of the various means of applying a releasing a force to deflect the edge 122 of the actuator 12 (both flat and arcuate), thereby producing the desired electrical signal is included in: commonly owned U.S. Pat. No. 6,630,894 entitled “Self-Powered Switching Device”; co-owned U.S. Pat. No. 6,812,594 entitled “Self-Powered Trainable Switching Network”; co-owned U.S. Pat. No. 7,084,529 entitled “Self-Powered Switch Initiation System”; co-owned U.S. Pat. No. 7,126,497 entitled “Self-Powered Switch Initiation System”; and co-owned U.S. Pat. No. 7,161,276 entitled “Self-Powered, Electronic Keyed Multifunction Switching System,” all of which are hereby incorporated by reference.

As previously mentioned, the applied force causes the piezoelectric transducer 12 to deform. By virtue of the piezoelectric effect, the deformation of the piezoelectric element 67 generates an instantaneous voltage between the faces 12a and 12c of the transducer 12, which produces a pulse of electrical energy. Furthermore, when the force is removed from the piezoelectric transducer 12, the transducer 12 recovers its original arcuate shape. This is because the bending of the substrate (and attached layers) stores mechanical (spring) energy which is released upon removal of the force. Additionally, the substrate or prestress layers 64 and 68 to which the ceramic 67 is bonded exert a compressive force on the ceramic 67, and the transducer 12 thus has an additional restoring force that causes the transducer 12 to return to its undeformed neutral state. On the recovery stroke of the transducer 12, the ceramic 67 returns to its undeformed state and thereby produces another electrical pulse of opposite polarity. The downward (applied) or upward (recovery) strokes cause a force over a distance that is of sufficient magnitude to create the desired electrical pulse. The duration of the recovery stroke, and therefore the duration of the pulse produced, is preferably in the range of 50-100 milliseconds, depending on the mechanical properties of the transducer, including its natural frequency of vibration.

Referring to FIG. 4.: In the preferred embodiment of the invention, the transducer 12 is clamped at one end 121 and the mechanical impulse is applied to the edge on the free end 122, i.e., at the end opposite to the clamped end 121 of the transducer 12. By applying the force to the edge on the free end 122 of the transducer 12 and releasing it, the actuator oscillates between the release position, to another position past the undeformed position, and then dampedly oscillates between the deformed positions returning to the undeformed position, by virtue of the substrates (spring steel) restoring force. Therefore, the electrical pulse that is generated upon removal of the force is an oscillating wave (rather than a single pulse as with the prior actuating means disclosed above).

Referring again to FIG. 4: FIG. 4 illustrates one embodiment of a device for generating an oscillating electrical signal by application of mechanical force to an end 122 of the transducer 12. This device comprises a transducer 12 mounted between a base plate 70 and a clamping member 75 as well as a deflector assembly 72. The base plate 70 is preferably of substantially the same shape (in plan view) as the transducer 12 attached thereon, and most preferably rectangular. One end 121 of the piezoelectric transducer 12 is held in place between the clamping member 75 and the upper surface 70a of a base plate 70, preferably on one end thereof. The clamping member 75 comprises a plate or block having a lower surface 75a designed to mate with the upper surface 70a of the base plate 70 with the transducer 12 therebetween. The device also has means for urging 76 the mating surface 75a of the clamping block towards the upper surface 70a of the base plate 70. This allows the lower surface 75a of the clamping plate 75 to be substantially rigidly coupled to the upper surface 70a of the base plate 70, preferably towards one side of the switch plate 70. The means for urging 76 together the mating surfaces 70a and 75a of the base plate 70 and clamping plate 75 may comprise screws, clamping jaws or springs or the like. Most preferably the urging means 76 comprises at least one screw 76 passing through the clamping member 75 and into a screw hole 77 in the upper surface 70a of the base plate 70.

One end 121 of a transducer 12 is placed between the mating surfaces 70a and 75a of the base and clamping plates 70 and 75. The mating surfaces 70a and 75a are then urged towards each other with the screw 76 to rigidly hold the end 121 of the transducer 12 in place between the base and clamping plates 70 and 75 with the opposite end 122 of the transducer 12 free to be moved by a mechanical impulse applied manually or preferably by a deflector assembly 72. The transducer 12 may further be aligned and securely retained between the base plate 70 and clamping plate 75 by means of one or more pins (not shown) on the base plate 70 and/or clamping plate 75 and holes (not shown) in the end 121 of the transducer 12.

Referring now to FIG. 5: In the preferred embodiment of the invention the surfaces 70a and 75a of the base and clamping plate 70 and 75 are designed to best distribute pressure evenly along the end 121 of the transducer 12 therebetween. To this end the upper surface 70a of the base plate 70 contacting the end 121 of the transducer 12 is preferably substantially flat and lower surface 75a of the clamping member 75 preferably has a recess 74 therein which accommodates insertion of the transducer end 121 therein. Preferably the depth of the recess 74 is equal to half the thickness of the transducer substrate 64, but may be as deep as the substrate thickness. Thus, the end 121 of the transducer 12 may be placed between the recess 74 and the upper surface 70a of the base plate 70 and secured therebetween by the screw 76. Alternatively, either or both of the mating surfaces 70a and 75a of the base and clamping plates 70 and 75 may have a recess therein to accommodate insertion and retention of the end 121 of the transducer 12 therebetween. The portion of the bottom surface 75a of the clamping member 75 beyond the recess 74 has no contact with the transducer 12, and is that portion through which the screw 76 passes. This portion of the bottom surface 75a may contact the upper surface 70a of the base plate 70, but most preferably there is a small gap (equal to the difference of the substrate thickness and the recess depth) between the lower surface 75a of the clamping member 75 and the top surface 70a of the base plate 70 when the transducer 12 is inserted therebetween. In yet another embodiment of the invention, the mating surfaces 70a and 75a of the base and clamping plates 70 and 75 may be adhesively bonded together (rather than screwed) with the end 121 of the transducer 12 sandwiched therebetween. In yet another alternative embodiment of the device, the clamping member 75 and base plate 70 may comprise a single molded structure having a central slot into which may be inserted one end 121 of the transducer 12.

The clamping assembly 75 holds the transducer 12 in place in its relaxed, i.e., undeformed state above the base plate 70 with the free end 122 of the transducer 12 in close proximity to a deflector 72 assembly. More specifically, the transducer 12 is preferably clamped between the mating surfaces 70a and 75a of the base and clamping plates 70 and 75 with the convex face 12a of the transducer 12 facing the base plate 70. Since the transducer 12 in its relaxed state is arcuate, the convex face 12a of the transducer 12 curves away from the upper surface 70a of the base plate 70 while approaching the free end 122 of the transducer 12. Mechanical force may then be applied to the free end 122 of the transducer 12 in order to deform the electroactive element 67 to develop an electrical signal.

Because of the composite, multi-layer construction of the transducer 12 it is important to ensure that the clamping member 75 not only holds the transducer 12 rigidly in place, but also that the transducer 12 is not damaged by the clamping member 75. In other words, the transducer 12, and more specifically the ceramic layer 67, should not be damaged by the clamping action of the clamping member 75 in a static mode, but especially in the dynamic state when applying a mechanical impulse to the transducer 12 with the plunger 72. For example, referring to FIG. 4, when a mechanical impulse is applied to the transducer 12 in the direction of arrow 81, the bottom corner of the ceramic (at point C) contacts the base plate 70 and is further pushed into the base plate, which may crack or otherwise damage the ceramic layer 67.

Referring again to FIG. 5: It has been found that the tolerances between the mating surfaces 75a and 70a of the clamping and base plates 75 and 70 are very narrow. It has also been found that application of a downward force (as indicated by arrow 81) to the free end 122 of the transducer 12 would cause the ceramic element 67 of the transducer 12 to contact the upper surface 70a of the base plate 70, thereby making more likely damage to the ceramic 67. Therefore, in the preferred embodiment of the invention, the base plate 70 has a recessed area 80 in its upper surface 70a which not only protects the electroactive element 67 from damage but also provides electrical contact to the convex face 12a of the transducer 12 so that the electrical signal developed by the transducer 12 may be applied to downstream circuit elements.

As can be seen in FIG. 5, one end 121 of the transducer 12 is placed between the surfaces 75a and 70a of the clamping and base plates 75 and 70 such that only the substrate 64 contacts both surface 75a and 70a. The clamping plate 75 preferably contacts the concave surface 12b of the transducer 12 along the substrate 64 up to approximately the edge of the ceramic layer 67 on the opposite face 12a of the transducer 12. The clamping member may however extend along the convex face 12c further than the edge C of the ceramic layer 67 in order to apply greater or more even pressure to the transducer 12 surfaces 12a and 12c between the clamping member 75 and base plate 70. The ceramic layer 67 which extends above the surface of the substrate 64 on the convex face 12a extends into the recessed area 80 of the switch plate 70. This prevents the ceramic layer 67 from contacting the upper surface 70a of the base plate 70, thereby reducing potential for damage to the ceramic layer 67.

The recess 80 is designed not only to prevent damage to the ceramic layer 67, but also to provide a surface along which electrical contact can be maintained with the electrode 68 on the convex face of the transducer 12. The recess 80 extends into the base plate 70 and has a variable depth, preferably being angled to accommodate the angle at which the convex face 12a of the transducer 12 rises from the recess 80 and above the top surface 70a of the base plate 70. More specifically, the recess 80 preferably has a deep end 81 and a shallow end 82 with its maximum depth at the deep end 81 beneath the clamping member 75 and substrate 12 just before where the ceramic layer 67 extends into the recess 80 at point C. The recess 80 then becomes shallower in the direction approaching the free end 122 of the transducer 12 until it reaches its minimum depth at the shallow end 82.

The recess 80 preferably contains a layer of compliant material 85 (preferably rubber, but alternately cork, urethane, silicone, felt or the like) along its lower surface which helps prevent the ceramic layer 67 from being damaged when the transducer 12 is deformed and the lower edge C of the ceramic layer 67 is pushed into the recess 80. Preferably the compliant layer 85 is of substantially uniform thickness along its length, the thickness of the compliant layer 85 being substantially equal to the depth of the recess 80 at the shallow end 82. The length of the compliant layer 85 is preferably slightly shorter than the length of the recess 80 to accommodate the deformation of the compliant layer 85 when the transducer 12 is pushed into the recess and compliant layer 85.

The compliant layer 85 preferably has a flexible electrode layer 90 overlying it to facilitate electrical contact with the aluminum layer 68 on the ceramic layer 67 on the convex face 12a of the transducer 12. More preferably, the electrode layer 90 comprises a layer of copper overlaying a layer of KAPTON film, as manufactured by E.I. du Pont de Nemours and Company, bonded to the compliant layer 85 with a layer of adhesive, preferably CIBA adhesive. The electrode layer 90 preferably extends completely across the compliant layer 85 from the deep end 81 to the shallow end 82 of the recess 80 and may continue as far as desired beyond the recess 80 along the top surface 70a of the base plate 70.

In the preferred embodiment of the invention, the end 121 of the transducer 12 is not only secured between the clamping plate 75 and the base plate 70, but the second prestress layer 68 covering the ceramic layer 67 of the transducer 12 is in constant contact with the electrode layer 90 in the recess 80 at all times, regardless of the position of the transducer 12 in its complete range of motion. To this end, the depth of the recess 80 (from the top surface 70a to the electrode 90) is at least equal to a preferably slightly less than the thickness of the laminate layers (adhesive layers 66, ceramic layer 67 and prestress layer 68) extending into the recess 80. The electrode layer is preferably adhered to either or both the aluminum layer 68 and the compliant layer 85, with a suitable adhesive, including for example, conductive adhesives.

An assembly was built having the following illustrative dimensions. The transducer 12 comprised a 1.59 by 1.79 inch spring steel substrate that was 8 mils thick. A 1-1.5 mil thick layer of adhesive having a nickel dust filler in a 1.51 inch square was placed one end of the substrate 0.02 inch from three sides of the substrate (leaving a 0.25 inch tab on one end 121 of the transducer 12). An 8-mil thick layer of PZT-5A type piezoelectric material in a 1.5 inch square was centered on the adhesive layer. A 1-mil thick layer of adhesive (with no metal filler) was placed in a 1.47 inch square centered on the PZT layer. Finally, a 1-mil thick layer of aluminum in a 1.46 inch square was centered on the adhesive layer. The tab 121 of the transducer 12 was placed in a recess in a clamping block 76 having a length of 0.375 inch and a depth of 4 mils. The base plate 70 had a 0.26 in long recess 80 where the deep end 81 of the recess had a depth of 20 mils and tapered evenly to a depth of 15 mils at the shallow end 82 of the recess 80. A rubber compliant layer 85 having a thickness of 15 mils and a length of 0.24 inches was placed in the recess 80. An electrode layer of 1 mil copper foil overlying 1 mil KAPTON tape was adhered to the rubber layer and extended beyond the recess 1.115 inches. The clamping member 75 was secured to the base plate 70 with a screw 76 and the aluminum second prestress layer of the transducer 12 contacted the electrode 90 in the recess 80 substantially tangentially (nearly parallel) to the angle the transducer 12 thereby maximizing the surface area of the electrical contact between the two.

As shown in FIG. 5, in an alternate embodiment of the invention, a weight 95 may be attached to the free end 122 of the transducer 12. The addition of the mass 95 to the free end 122 of the transducer 12, decreases the amount of damping of the oscillation and thereby increases the duration of oscillation of the transducer 12 when it was deflected and released. By having a longer duration and higher overall amplitude oscillation, the transducer 12 is capable of developing more electrical energy from its oscillation than an transducer 12 having no additional mass at its free end 122.

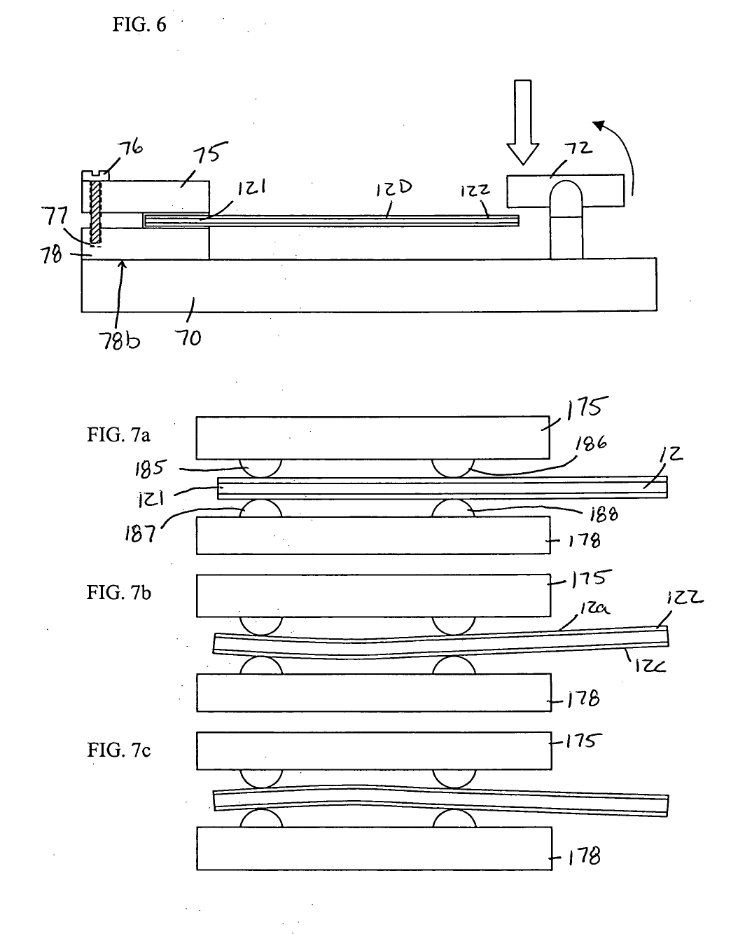

As shown in FIG. 6, in an alternate embodiment of the invention, a transducer 12, 12B, 12D may be mounted in a cantilever fashion. In FIG. 6, the transducer 12D pictured is that of FIG. 2A, but other transducers 12 or 12B may be similarly mounted. This mount also includes a base plate 70 and clamping plates 75, 78 for retaining the clamped end 121 of the transducer 12 therebetween, as well as deflector 72 mounted to the base plate 70 in proximity to the free end 122 of the transducer 12. The lower clamping plate 78 is rigidly connected to the base plate 70 at its lower surface 78b, and holds the transducer 12 on its top surface 78a above the top surface of the base plate 70, which allows the deflector 72 to deform the free end 122 of the transducer 12 up to the distance equal to the lower clamping plate's 78 thickness. The upper clamping plate 75 and lower clamping plate 78 hold the free end 121 of the transducer 12 therebetween through use of urging means, including the screw 76 and screw hole 77 pictured. Although the preferred embodiment of the invention uses a screw 76, other means for urging 76 the plates 75, 78 together may be used, such as clamping jaws, springs, clips, adhesives and the like.

Referring now to FIGS. 7a-7c: An alternate means for clamping the transducer 12 is shown, wherein each of the clamping plates 175, 177 has rounded projections thereon, for retaining the transducer 12, yet allowing some bending or the transducer 12 between the plates 175, 177, in order to distribute and reduce point bending forces on the retained portion 121 of the transducer 12. The clamping plates 175, 177 are urged together, preferably using one or more screws or bolts (not shown). In the preferred embodiment of the clamping plates 175, 177, the upper clamping plate 175 has two rounded projections 185, 186 thereon and the lower clamping plate 177 also has two rounded projections 187, 188 thereon. Each projection 185-188 is preferably shaped substantially like a half cylinder with the radius of the cylinder extending from the mating faces of the clamping plates 175, 177, and in the height dimension of the half cylinder are substantially perpendicular to the direction along which the transducer 12 extends from the plates 175, 177. The projections are constructed of a rigid, durable material such as metal or hard plastic. Each of the projections 185, 186 and 187, 188 are parallel to each other and equidistant, i.e., projections 185 and 186 are parallel and separated by the same distance as parallel projection 187 and 188. This facilitates placing the end 121 of the transducer 12 between the projections 185-188 so that the end 121 is retained between the plates 175, 177 along two parallel lines corresponding to the projections 185, 187 and 186, 188 on either side of the respective lines. The projections may alternately comprise multiple hemispherical projections, wherein each projection 185-188 comprises two or more hemispherical projections situated along the same axis as the semi-cylindrical projections 185-188.

As can be seen in FIGS. 7a-7c, when the free end 122 of transducer 12 is deflected as shown by arrows 191 and 192, the end 121 of the transducer 12 between the projections 185-188 is allowed to bend between and around the projections 185-188. Furthermore, the rounded shape of the projections 185-188 reduces point bending stresses in the transducer 12. This is because as the transducer 12 bends, the lines along which the projections 185, 187 and 186, 188 retain the transducer 12 actually shift slightly off of center (i.e., the apex of the projection) so that the transducer 12 is contacted at different points depending upon the amount the transducer 12 is deflected. This configuration allows the retained end 121 of the transducer 12 to bend without point stresses by distributing the stresses, thereby increasing the durability of the transducer 12, and also providing less attenuation to the desired oscillation of the transducer 12 due to the clamping.

Electrical contact to each of the faces 12a, 12c of the transducer 12 may be provided by use of wires 14 soldered to each face 12a, 12c. Alternately, conductive foil may be adhered to each face 12a, 12c of the transducer 12. As yet another alternative, by using metallic projections 185-188 on the clamping plates 175, 177, electrical contact with each of the faces 12a, 12c of the transducer 12 may be maintained, and conductors 14 may be attached to one or both of the projections 185, 186 and 187, 188 on each side 12a, 12c of the transducer 12, or alternately to the projections 185, 186 and 187, 188 via each of the plates 175, 177. By making electrical connections to conductive projections 185-188, bending and point stresses are eliminated from the conductors 14 electrically connected to each face 12a, 12c of the transducer 12 as it is bent.

Referring to FIGS. 4-6: As mentioned above, it is desirable to generate an electrical signal by deforming the transducer 12. Deformation of the transducer 12 may be accomplished by any suitable means such as manually or by mechanical deflection means such as a plunger, lever or the like. In FIGS. 6-8 a simple deflector 72 is mounted to the base plate 70 in proximity to the free end 122 of the transducer 12. This deflector assembly 72 includes a lever 86 having first and second ends 87 and 88. The lever is pivotably mounted between the two ends 87 and 88 to a fulcrum 89. By exerting a force on the first end 87 of the lever 86 in the direction of arrow 91, the lever pivots about the fulcrum 89 and applies a mechanical impulse in the direction of arrow 81 to the free end 122 of the transducer 12. Alternatively, the lever 86 may be moved opposite the direction of arrow 91 and the transducer 12 may thus be deflected in the direction opposite arrow 81.

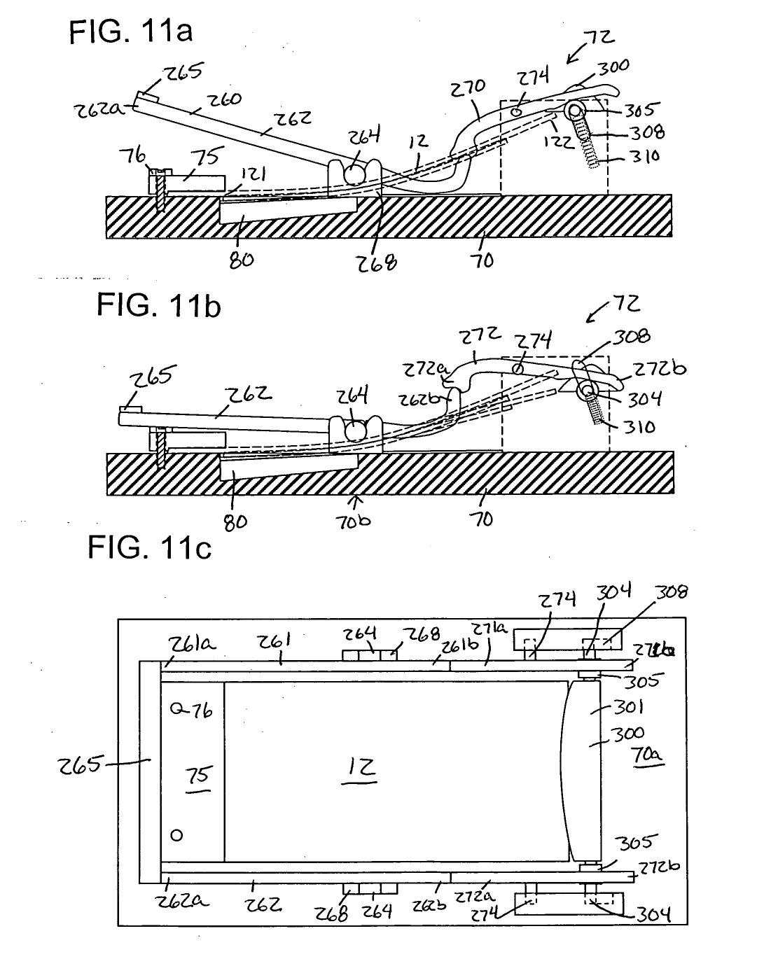

Referring now to FIGS. 11a-a-c: FIGS. 11a-a-c show the preferred embodiment of a base plate 70 with a deflector assembly 72 and containing the transducer 12. The transducer 12 is mounted as in FIG. 7, with one end 121 of the transducer 12 placed between the surfaces the clamping and base plates 75 and 70 such that the substrate 64 contacts both surfaces 75a and 70a. Alternately, the end 121 of the transducer 12 may be mounted between clamping plates 185, 187 as shown in FIGS. 7a-a-c. The ceramic layer 67 which extends above the surface of the substrate 64 on the convex face 12a extends into the recessed area 80 of the base plate 70. This prevents the ceramic layer 67 from contacting the upper surface 70a of the base plate 70, and cushions the ceramic layer 67 against the compliant layer 85 in the recess 80, thereby reducing potential for damage to the ceramic layer 67. A deflector assembly 72 is mounted on the base plate 70 above and to the sides of the transducer 12. This deflector assemble 72 has a lower profile than previously described deflector assemblies 72 by virtue of the use of two cooperating counter-rotating lever assembles 260, 270 and a plucker assembly 300.

Referring again to FIGS. 11a-c: The deflector assembly comprises a swing arm 260, which is essentially a first lever mounted above the clamped end 121 of the transducer 12 and tending towards the free end 122. The swing arm 260 preferably has two pivot arms 261 and 262 connected by a cross bar 265. The pivot arms 261 and 262 tend from above the clamped end 121 of the transducer 12 and tending towards the free end 122 of the transducer 12, along each side of the transducer 12 to prevent contact therebetween. A first end 261a, 262a of each pivot arm 261, 262 is connected to the two ends of a cross bar 265, which is situated above the clamping plate 75. Each pivot arm 261, 262, has a pin 264 extending outwardly from the transducer 12, located centrally on the pivot arms 261, 262. The pins are pivotably mounted within fulcrum clips 268, which allows the swing arm assembly 260 to pivot about the pins 264 and the fulcrum clips 268. The ends 261b, 262b of the pivot arms 261, 262 opposite the crossbar 265 are preferably upwardly curved to tend substantially vertically, or more preferably slightly off vertical and towards the free end 122 of the transducer 12 and rocker arm 270 assemblies. The curved ends 261,b, 262b of the pivot arms 261, 262 may alternately be C-shaped, i.e., first curve downwardly (towards the base plate 70, and then upwardly. To accommodate the downward curve of the pivot arm ends 261b, 262b, the base plate 70 may contain recesses (not shown) within which the curved ends 261b, 262b may housed.

Referring again to FIGS. 11a-a-c: The deflector assembly also comprises a rocker assembly 270, which is essentially a pair of second levers 271, 272 mounted above the free end 122 of the transducer 12 and tending towards and beyond the free end 122. The rocker assembly 270 preferably has two rocker arms 271 and 272 pivotably mounted to contact both the pivot arms 261, 262 and the plucker assembly 300. The rocker arms 271 and 272 tend from above the curved ends 261b, 262b of the pivot arms 261, 262 and tend towards and slightly beyond the free end 122 of the transducer 12, and along each side of the transducer 12 to prevent contact therebetween. Each of the rocker arms 271, 271 has a pin 274 thereon, extending outwardly from the transducer 12. Each of these pins 274 is pivotably mounted within a pivot hole 278 of the plucker housing 290. This allows each rocker arm 271, 272, to rotate about its respective pin 274 in response to a force on either end 271a, 272a, 271b, 272b of the rocker arm 271, 272. Each first end 271a, 272a of the rocker arms 271, 272 is in contact with the second ends 261b, 262b of the pivot arms 261, 262. When the crossbar 265 is depressed, the second ends 261b, 262b of the pivot arms 261, 262 move upwardly and contact the first ends 271a, 272a of the rocker arms 271, 272, causing the rocker arms 271, 272 to rotate about the rocker arm pins 274. This causes the second ends 271b, 272b of the rocker arms 271, 272 to be depressed.

Referring again to FIGS. 11a-a-c: The deflector assembly also comprises a plucker assembly 300, which is essentially a slidably mounted curved paddle situated above the free end 122 of the transducer 12. The plucker assembly 300 is in contact with the rocker assembly 270 and is adapted to side downwardly within a pair of grooves in response to a downward motion from the second ends 271b, 272b of the rocker arms 271, 272. More specifically, the plucker assembly 300 comprises a plucker paddle 301, situated above and in contact with the free end 122 of the transducer 12. Connected to each end 301a, 301b of the plucker paddle 301 is a roller 305, which is in contact with the rocker arms 271, 272. Tending outwardly from each roller 305 is a slide pin 304. The slide pins 304 are slidably mounted within slide grooves 308 in the plucker housings 290. The slide grooves 308 tend from a maximum vertical position and downwardly away from the free end 122 of the transducer 12 to a minimum position beyond the free end 122 of the transducer 12. Thus, when the plucker assembly 300 is moved downwardly, the slide pins 304 and slide grooves 308 cause the plucker paddle 301 to move simultaneously downward and away from the free end of 122 the transducer 12.

Thus, when the crossbar 265 is depressed, the second ends 261b, 262b of the pivot arms 261, 262 move upwardly and contact the first ends 271a, 272a of the rocker arms 271, 272, causing the rocker arms 271, 272 to rotate about the rocker arm pins 274. This causes the second ends 271b, 272b of the rocker arms 271, 272 to be depressed. As the second ends 271b, 272b of the rocker arms 271, 272 are depressed, they contact the rollers 305 with a downward force, and the plucker assembly 300 is guided by the slide pins 304 and slide grooves 308 to cause the plucker paddle 301 to move simultaneously downward and away from the free end of 122 the transducer 12. The minimum or lowest position of the plucker assembly is beyond the free end 122 of the transducer 12, and therefore, as the plucker paddle 301 moves downward and outward, the free end 122 of the transducer 12 is released by the plucker paddle 301. Thus as the plucker assembly is depressed, the free end 122 of the transducer 12 is depressed from its neutral position 291 to a deflected position 292 at which position the paddle 301 releases the free end 122 of the transducer 12. The free end 122 of the transducer 12 then oscillates between positions 291 and 292.

Referring now to FIG. 11c: The plucker paddle 301 preferably has an edge 301a that contacts the free end 122 of the transducer 12 that has a radius in both in the thickness dimension (i.e., vertically corresponding to the thickness of the transducer 12 edge) and the transverse dimension (i.e., horizontally corresponding to the length of the transducer 12 edge) in order to advantageously release the free end 122 very quickly, i.e., without dragging across the end 122 of the transducer 12, which slows its release. It has been found that the more quickly and cleanly you release the end 122 of the transducer 12 during a “pluck”, the greater the output. This increases output without increasing the required plucking force. To be precise, the energy developed by the piezoelectric element 67 has been found to be a function of the acceleration of the piezoelectric element 67, rather than the speed of the “pluck.” It is possible “pluck” very slowly, and get excellent performance, so long as the piezoelectric element 67 is released fully and completely and as nearly instantly as possible. To determine the desired shape of the tip 301a of the plucker paddle 301, several plucker paddles were designed and released very, very slowly, in attempting to get a quick “release” of the end 122 of the transducer 12. If the plucker paddle 301 did not have a radius on the tip, but instead had a rectangular shape, it was found that the end 301a of the plucker paddle 301 (the thickness dimension) actually “dragged” across the edge 122 of the transducer 12, slowing the release, and decreasing the electrical output. Thus, increasing the rate of “release” of the element's edge 122 improved the acceleration and the output. Thus, the radius of the tip 301a (in the thickness dimension) of the “plucker” paddle 301 contributes substantially to how quickly the transducer 12 edge 122 gets off the paddle. This has been shown to have a direct effect on electrical performance, because a smaller radius equates to a quicker “release” which equates to greater electrical output. If the paddle 301 is manufactured from sufficiently hard materials, or is hardened, the edge 301a of the paddle 301 can be made with an even smaller radius. The tip 301a of the plucking paddle 301 may be coated with a very hard material with low friction, thereby lowering the plucking resistance. This approach can prove to be useful in increasing the power output of a transducer 12 without increasing the required displacement or amount of bending, and may allow the generation of the same amount of energy with lower “button force” by the user of the device, as well as being useful in increasing wear resistance for applications requiring many hundreds of thousands of switch cycles.

The transducer 12 is typically is curved along its length, i.e., the longitudinal dimension and this curvature allows the element 12 to be bent or “plucked” substantially before it reaches a flattened state. The transducer 12 is also curved across its transverse dimension, i.e., the transverse dimension normal to the thickness and longitudinal dimensions. To ensure a quick “release”, the shape of the edge 301a of the plucking paddle 300 should generally match this transverse curve. The radius curvature of the transducer 12 in the transverse plane is approximately 6 inches, and therefore the same radius should be used for the curve edge 301a in the transverse plane of the paddle 301. Different sized transducers 12 will have higher or lower transverse radii of curvature, so regardless of the size of the transducer 12, the radius of curvature for the curved edge 301a in the transverse plane of the paddle 301 should substantially match the transverse curvature of the transducer 12.

Although both paddle 301 dimensions affect durability, and both dimensions affect performance, the tip radius has more of an effect on element 12 performance, while the transverse curve has a greater effect on the element's 12 substrate wear, and therefore is more of an influence on its life expectancy. This is because the transverse radius determines how much of the paddle 301 contacts the element 12. A greater contact area is equates with less wear and longer substrate life, i.e., durability. As stated above, by manufacturing the paddle 301 from sufficiently hard or hardened materials, the edge 301a of the paddle 301 can be made with very small radius. The tip 301a of the plucking paddle 301 may be coated with a very hard material with low friction, thereby lowering the plucking resistance. Hardened, low friction materials are useful in increasing the power output of a transducer 12 without increasing the required displacement or amount of bending, or allowing the generation of similar electrical energy output with lower “button force”, and increasing wear resistance.

Referring again to FIGS. 11a-c: In order to return the deflector assembly 72 to its normal elevated position, the levers 260, 270 and/or plucker assembly 300 are preferably spring loaded. More specifically, one or more springs 310 are located in contact with the deflector assembly 72, and are placed in compression or tension upon actuation of the assembly 72, which springs' 310 restoring force is used to return the deflector assembly 72 to its neutral position. As shown in FIGS. 11a-c, in the preferred embodiment of the invention, two springs 310 are located within cavities 320 in the plucker housings 290, below the pins 304. For simplicity of illustration, the springs 310 are shown as coiled springs 310, but are preferably leaf springs 310. Upon downward deflection of the crossbar 265 and thereby the pivot bar assembly 260 and rocker assembly 270, the pins 304 travel down the grooves 308 and compress the springs 310 in the cavities 320. Upon release of pressure from the crossbar 265, the springs 310 restore the pivot bar 260, rocker bars 270 and plucker 300 to their undeflected positions. While the springs 310 shown are in the housings 290, other placements of the springs 310 may also be desirable, including, for example: spring(s) 310 may be placed beneath the cross bar 265, on either side of the fulcrum 268 of the pivot bars 261, 262 or rocker arms 270; one or more rotational or clock springs 310 may be placed on the pins 264 of the pivot bars 261, 262, on the pins 274 of the rocker arms 271, 272, on the pivot bar fulcrums 268, or the rocker arm pin holes 278; springs 310 may be placed in the groove 308 or recess 320 above or below the plucker bar pins 304; one or more springs 310 may be attached to the plucker bar 301; and the opposing side of the spring 310 (not attached to the deflector assembly 72) may be attached to the base plate 70, the plucker housing 290, the fulcrum 268 or to another part of the deflector assembly 72 to restore it to its undeflected position.

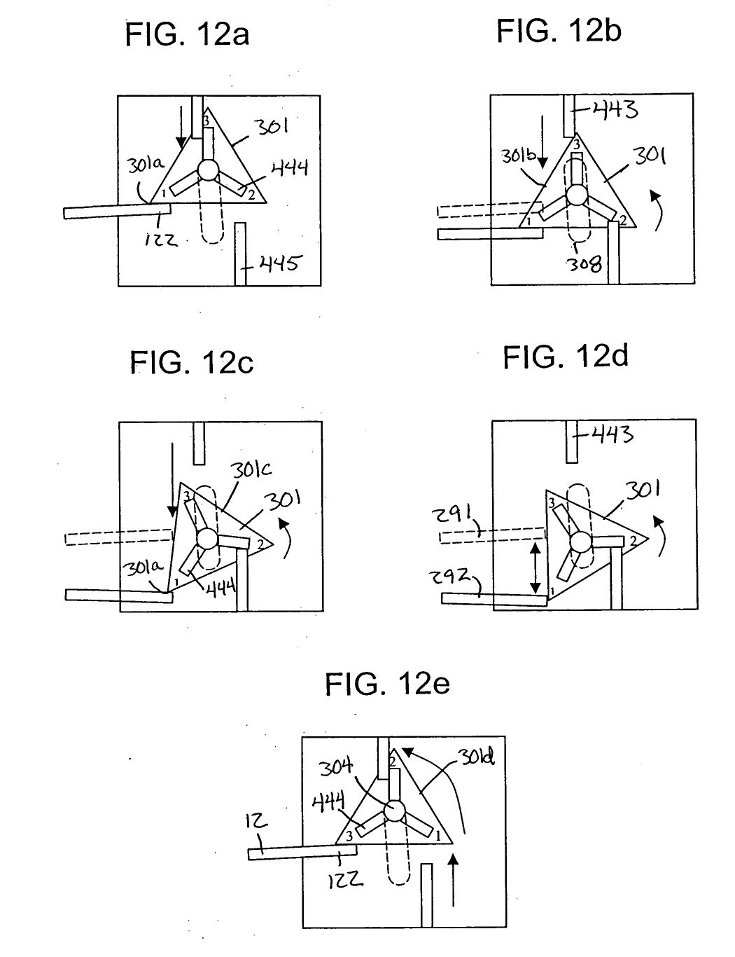

Referring now to FIGS. 12a-e: To facilitate efficient plucking and maximize vibration of the transducer 12, the plucker assembly is preferably configured so as to rotate during each actuation and to cock after each actuation. Specifically, with a triangularly shaped plucker paddle 301, any one of the three faces 301b, 301c, 301d of the plucker paddle 301 (having a substantially triangular cross-section) may engage the edge of the transducer. As the plucker paddle 301 moves downward and outward from the transducer edge, a rotation mechanism (including a pin 445 and radial ridge 444 as shown in the figures) causes the plucker paddle edge to rotate away from the transducer edge 122. As the plucker paddle rotates, it reaches a point where the transducer edge 122 is released. Since the plucker paddle 301 has rotated, it also does not interfere with the vibration of the transducer edge. When the downward force is removed from the plucker assembly, the spring loaded plucker paddle 301 is returned upward towards its starting position, and rotates until the radial ridge 444 contacts a rotational stop 443, so that the plucker paddle 301 is again is a position to engage the transducer edge.

Referring again to FIGS. 12a-a-e: More specifically, the plucker paddle 301 is shaped substantially like a triangular prism. In the center of each triangular face of the paddle is a pin 304 that travels along the groove 308 in the plucker housing. Each triangular face of the paddle also preferably has threes raised ridges 444 thereon extending from the center of the triangular face outwardly towards the edges of the triangular faces adjacent the flat paddle surfaces and most preferably towards each apex of the triangular faces. The plucker housings each have a vertical ridge or pin 443 against which the raised ridge rests when the plucker paddle is in its maximum position. This maintains the bottom surface of the plucker paddle (opposite the apex bisected by the raised ridge) in an essentially horizontal position above and/or against the edge of the transducer 12.

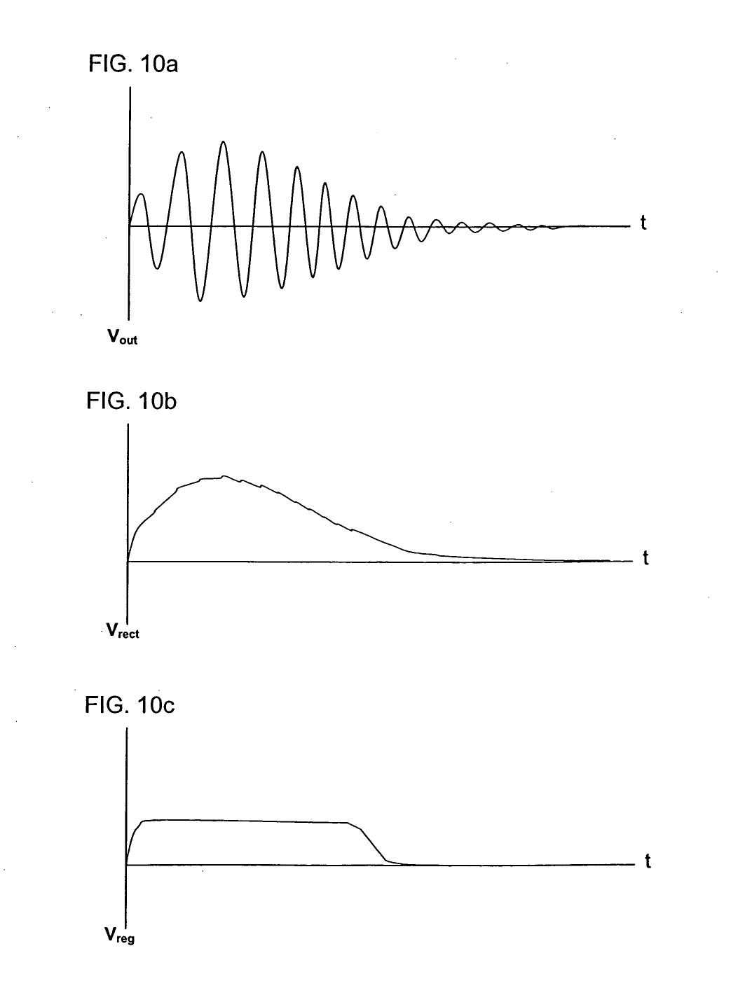

A force applied to the deflector assembly 72 described above causes the piezoelectric transducer 12 to deform from position 291 to position 292 and by virtue of the piezoelectric effect, the deformation of the piezoelectric element 67 generates an instantaneous voltage between the faces 12a and 12c of the transducer 12, which produces an electrical signal. Furthermore, when the force is removed from the piezoelectric transducer 12, i.e., when released by the plucker assembly 300 at position 292, the transducer 12 oscillates between positions 291 and 292 until it gradually returns to its original shape. As the transducer 12 oscillates, the ceramic layer 67 strains, becoming alternately more compressed and less compressed. The polarity of the voltage produced by the ceramic layer 67 depends on the direction of the strain, and therefore, the polarity of the voltage generated in compression is opposite to the polarity of the voltage generated in tension. Therefore, as the transducer 12 oscillates, the voltage produced by the ceramic element 67 oscillates between a positive and negative voltage for a duration of time. The duration of the oscillation, and therefore the duration of the oscillating electrical signal produced, is preferably in the range of 100-250 milliseconds, depending on the shape, mounting and amount of force applied to the transducer 12. The wave form of the oscillating voltage is illustrated in FIG. 10a.

When the end 122 of the transducer 12 is deflected and then released (either manually or using a deflector assembly 72 such as in FIGS. 4-9), the end 122 of the transducer 12, much like a diving board, oscillates back and forth between positions 291 and 292. This is because the substrate and prestress layer 64 and 68 to which the ceramic 67 is bonded exert a compressive force on the ceramic 67 thereby providing a restoring force. Therefore, the transducer 12 has a coefficient of elasticity or spring constant that causes the transducer 12 to return to its undeformed neutral state at position 291. The oscillation of the transducer 12 has the waveform of a damped harmonic oscillation, as is illustrated in FIG. 10a. In other words, the amplitude of the oscillation of the free end 122 of the transducer 12 is at its maximum immediately following (within a few oscillations after) the release of the mechanical impulse from the free end 122 of the transducer 12. As the transducer 12 continues to vibrate, the amplitude gradually decreases over time (approximately exponentially) until the transducer 12 is at rest in its neutral position 291, as shown in FIG. 10a.

The applied force, whether by manual or other mechanical deflection means 72 causes the piezoelectric transducer 12 to deform and by virtue of the piezoelectric effect, the deformation of the piezoelectric element 67 generates an instantaneous voltage between the faces 12a and 12c of the transducer 12, which produces an electrical signal. Furthermore, when the force is removed from the piezoelectric transducer 12, the transducer 12 oscillates between positions 291 and 292 until it gradually returns to its original shape. As the transducer 12 oscillates, the ceramic layer 67 strains, becoming alternately more compressed and less compressed. The polarity of the voltage produced by the ceramic layer 67 depends on the direction of the strain, and therefore, the polarity of the voltage generated in compression is opposite to the polarity of the voltage generated in tension. Therefore, as the transducer 12 oscillates, the voltage produced by the ceramic element 67 oscillates between a positive and negative voltage for a duration of time. The duration of the oscillation, and therefore the duration of the oscillating electrical signal produced, is preferably in the range of 100-500 milliseconds, depending on the shape, mounting and amount of force and number of plucks applied to the edge of the transducer 12.

The electrical signal generated by the transducer 12 is applied to downstream circuit elements via wires 14, and conductive foil, solder or conductive adhesive connected to the transducer 12. More specifically, a first wire 14 is connected to the electrode 90 which extends into the recess 80 and contacts the electrode 68 on the convex face 12a of the transducer 12 or to a foil adhered to the lower face 12a of the transducer 12. Preferably the wire 14 is attached to a conductive foil (not shown) adhered to the face 12a of the transducer 12 situated above the recess 80 and compliant layer 85. Alternately, the wire 14 is connected to the electrode 90 outside of the recess close to the end of the base plate 70 opposite the end having the clamping member 75. A second wire 14 is connected directly to the first prestress layer 64, i.e., the substrate 64 which acts as an electrode on the concave face 12c of the transducer 12.

Referring now to FIGS. 11a-a-c, 13-15: FIGS. 11a-a-c, 13-15 show an embodiment of a deflector assembly 72 containing the transducer 12 surrounded by a casing 200. The base plate 70 forms the base of a casing 200, which encloses the transducer 12. A button 210 is used to apply the force to the deflector assembly 72. The button 210 has a top surface 210a and four button sides 211, 212, 213 and 214 which extend substantially perpendicularly from the top surface 210a of the button 210. The button 210 is pivotably mounted via button hinge holes 215 in the sides 211, 213 of the button 210, which button hinge holes 215 are pivotably engaged with button hinge pins 216 which are fixedly mounted to a hinge base 217 on the base 70. When the button 210 is pushed, the button bottom surface 10b contacts the deflector assembly 72 thereby deforming/plucking the electroactive generator 72.

Surrounding the button 210 and mounted to the base plate 70 is a frame 250 having four walls 251, 252, 253 and 254 which extend perpendicularly from the top surface 70a of the base plate 70. There are preferably one or more clips along one or more of the wall 251, 252, 253 and 254 edges that engage with the edge of the bottom face 70b of the base 70.

The frame walls 251, 252, 253 and 254 may also have a tapered or beveled portion 225 above the vertical portion of the walls (where the walls attach to and surround the underlying base 70) beveling inward towards the button 210 in the center of the frame 250. The frame 250 is removable from the base 70 and when removed allows access to other components, for example the hinge 216 pins to which the button 210 is attached, or to access screw holes 228 in the base 70, which may be used to attach the base 70 to a wall or other mounting surface.

In each embodiment of a self powered RF signal generator, the transducer 12, base 70 and associated transmission circuitry are enclosed in a case, such as described above having a base 200, a button 210 and a frame 250. The case may be made of a variety of materials including plastics and metal or combinations thereof. Most preferably, the case 200 comprises plastic. It has been discovered that the character of the RF signal radiated from the antenna 60 in the transmitter circuit 126 varies with the placement of the antenna 60 in relation to parts of the casing 200 as well as other obstructions placed in proximity to the antenna. To this end it is preferred that the antenna 60 be fixedly mounted to the base 70. Most preferably, the antenna 60 is affixed to the casing in a channel in the base 70/200. Furthermore, it is preferable that at least a portion of the base 70 be made of metal. Objects (i.e., in walls) to which the base 70 is mounted may cause interference with the signal radiated from the antenna 60. Therefore a portion of the base 70 is preferred to be metallic in order to shield the antenna from any interference. Most preferably, a metallic foil 400 is affixed to the back face 70b of the base 70 in proximity to the antenna 60 on the opposite face 70a of the base 70.

### Switch Initiation System

The pulse of electrical energy is transmitted from the transducer or generator 12 via the electrical wires 14 connected to each of the transducer 12 to a switch or relay 90. The pulse of electrical energy is of sufficient magnitude to cause the switch/relay 90 to toggle from one position to another. Alternatively and preferably, the electrical pulse is first transmitted through a pulse modification circuit 10 in order to modify the character, i.e, current, voltage, frequency and/or pulse width of the electrical signal.

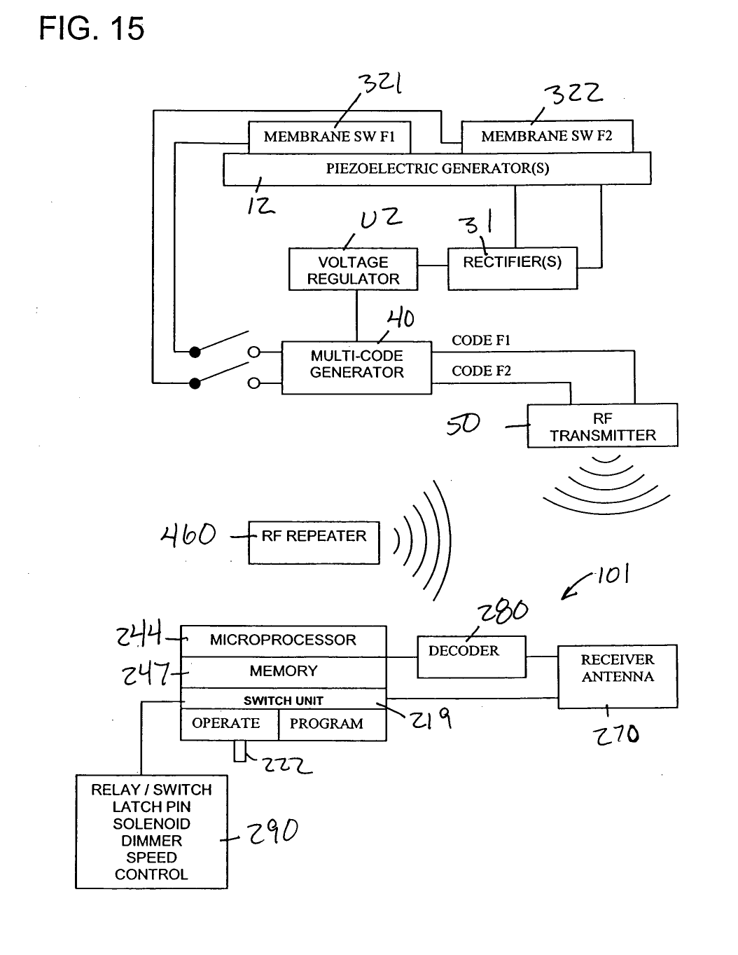

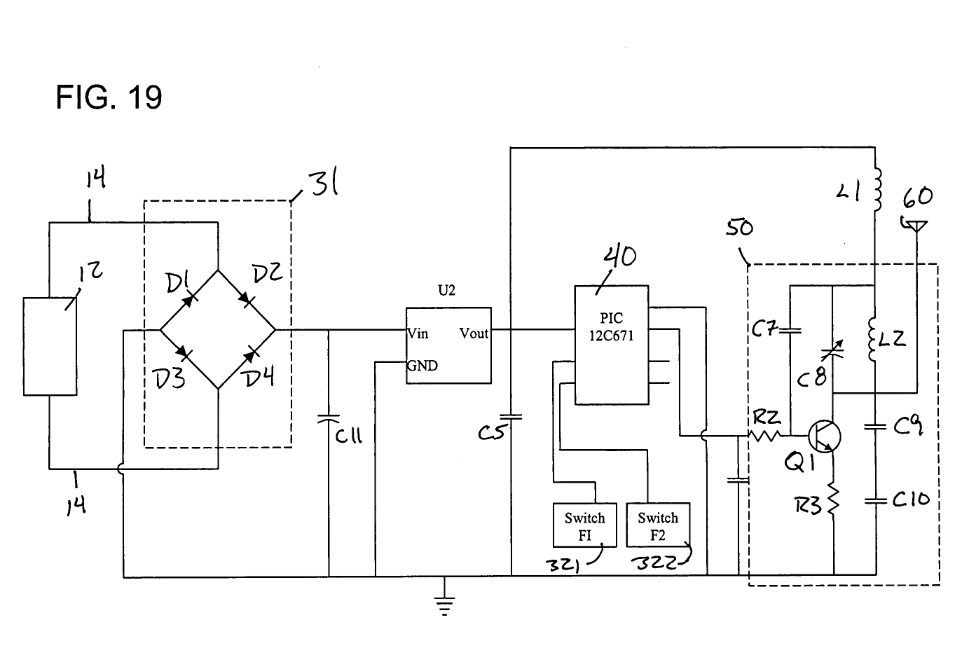

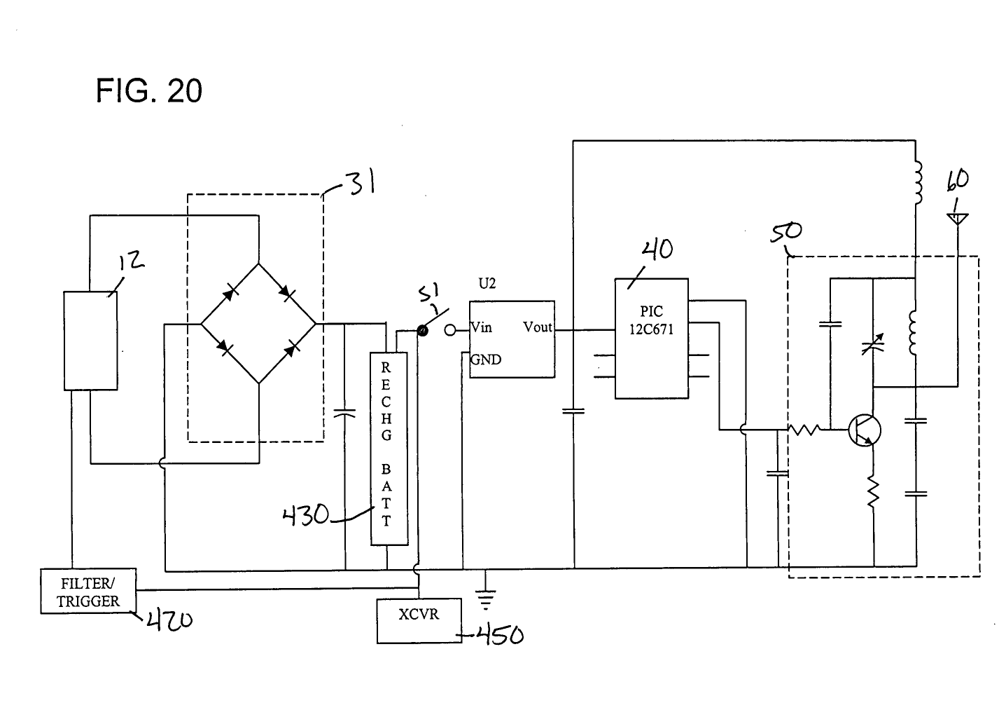

Referring to FIGS. 15-21: The transducer 12 is connected to circuit components downstream in order to generate an RF signal for actuation of a switch initiator. These circuit components include a rectifier 31, a voltage regulator U2, an encoder 40 (preferably comprising a peripheral interface controller (PIC) chip) as well as an RF generator 50 and antenna 60. FIG. 10b shows the waveform of the electrical signal of FIG. 10a after it has been rectified. FIG. 10c shows the waveform of the rectified electrical signal of FIG. 10b after it has been regulated to a substantially uniform voltage, preferably 3.3 VDC.

The transducer 12 is first connected to a rectifier 31. Preferably the rectifier 31 comprises a bridge rectifier 31 comprising four diodes D1, D2, D3 and D4 arranged to only allow positive voltages to pass. The first two diodes D1 and D2 are connected in series, i.e., the anode of D1 connected to the cathode of D2. The second two diodes D3 and D4 are connected in series, i.e., the anode of D3 connected to the cathode of D4. The anodes of diodes D2 and D4 are connected, and the cathodes of diodes D1 and D3 are connected, thereby forming a bridge rectifier. The rectifier is positively biased toward the D2-D4 junction and negatively biased toward the D1-D3 junction. One of the wires 14 of the transducer 12 is electrically connected between the junction of diodes D1 and D2, whereas the other wire 14 (connected to the opposite face of the transducer 12) is connected to the junction of diodes D3 and D4. The junction of diodes D1 and D3 are connected to ground. A capacitor C11 is preferably connected on one side to the D2-D4 junction and on the other side of the capacitor C11 to the D1-D3 junction in order to isolate the voltages at each side of the rectifier from each other. Therefore, any negative voltages applied to the D1-D2 junction or the D3-D4 junction will pass through diodes D1 or D3 respectively to ground. Positive voltages applied to the D1-D2 junction or the D3-D4 junction will pass through diodes D2 or D4 respectively to the D2-D4 junction. The rectified waveform is shown in FIG. 10b.

The circuit also comprises a voltage regulator U2, which controls magnitude of the input electrical signal downstream of the rectifier 31. The rectifier 31 is electrically connected to a voltage regulator U2 with the D2-D4 junction connected to the Vin pin of the voltage regulator U2 and with the D1-D3 junction connected to ground and the ground pin of the voltage regulator U2. The voltage regulator U2 comprises for example a LT1121 chip voltage regulator U2 with a 3.3 volts DC output. The output voltage waveform is shown in FIG. 10c and comprises a substantially uniform voltage signal of 3.3 volts having a duration of approximately 100-250 milliseconds, depending on the load applied to the transducer 12. The regulated waveform is shown in FIG. 10b. The output voltage signal from the voltage regulator (at the Vout pin) may then be transmitted via another conductor to the relay switch 290, in order to change the position of a relay switch 290 from one position to another. Preferably however, the output voltage is connected through an encoder 40 to an RF generation section 50 of the circuit.

The output of the voltage regulator U2 is preferably used to power an encoder 40 or tone generator comprising a peripheral interface controller (PIC) microcontroller that generates a pulsed tone. This pulsed tone modulates an RF generator section 50 which radiates an RF signal using a tuned loop antenna 60. The signal radiated by the loop antenna is intercepted by an RF receiver 270 and a decoder 280 which generates a relay pulse to activate the relay 290.

The output of the voltage regulator U2 is connected to a PIC microcontroller, which acts as an encoder 40 for the electrical output signal of the regulator U2. More specifically, the output conductor for the output voltage signal (nominally 3.3 volts) is connected to the input pin of the programmable encoder 40. Types of register-based PIC microcontrollers include the eight-pin PIC12C5XX and PIC12C67x, baseline PIC16C5X, midrange PIC16CXX and the high-end PIC17CXX/PIC18CXX. These controllers employ a modified Harvard, RISC architecture that support various-width instruction words. The datapaths are 8 bits wide, and the instruction widths are 12 bits wide for the PIC16C5X/PIC12C5XX, 14 bits wide for the PIC12C67X/PIC16CXX, and 16 bits wide for the PIC17CXX/PIC18CXX. PICMICROS are available with one-time programmable EPROM, flash and mask ROM. The PIC17CXX/PIC18CXX support external memory. The encoder 40 comprises for example a PIC model 12C671. The PIC12C6XX products feature a 14-bit instruction set, small package footprints, low operating voltage of 2.5 volts, interrupts handling, internal oscillator, on-board EEPROM data memory and a deeper stack. The PIC12C671 is a CMOS microcontroller programmable with 35 single word instructions and contains 1024×14 words of program memory, and 128 bytes of user RAM with 10 MHz maximum speed. The PIC12C671 features an 8-level deep hardware stack, 2 digital timers (8-bit TMR0 and a Watchdog timer), and a four-channel, 8-bit ND converter.

The output of the PIC may include square, sine or saw waves or any of a variety of other programmable waveforms. Typically, the output of the encoder 40 is a series of binary square waveforms (pulses) oscillating between 0 and a positive voltage, preferably +3.3 VDC. The duration of each pulse (pulse width) is determined by the programming of the encoder 40 and the duration of the complete waveform is determined by the duration of output voltage pulse of the voltage regulator U2. A capacitor C5 is preferably connected on one end to the output of the voltage regulator U2, and on the other end to ground to act as a filter between the voltage regulator U2 and the encoder 40.

Thus, the use of an IC as a tone generator or encoder 40 allows the encoder 40 to be programmed with a variety of values. The encoder 40 is capable of generating one of many unique encoded signals by simply varying the programming for the output of the encoder 40. More specifically, the encoder 40 can generate one of a billion or more possible codes. It is also possible and desirable to have more than one encoder 40 included in the circuit in order to generate more than one code from one transducer 12 or transmitter. Alternately, any combination of multiple transducers and multiple pulse modification subcircuits may be used together to generate a variety of unique encoded signals. Alternately the encoder 40 may comprise one or more inverters forming a series circuit with a resistor and capacitor, the output of which is a square wave having a frequency determined by the RC constant of the encoder 40.

The DC output of the voltage regulator U2 and the coded output of the encoder 40 are connected to an RF generator 50. A capacitor C6 may preferably be connected on one end to the output of the encoder 40, and on the other end to ground to act as a filter between the encoder 40 and the RF generator 50. The RF generator 50 consists of tank circuit connected to the encoder 40 and voltage regulator U2 through both a bipolar junction transistor (BJT) Q1 and an RF choke L1. More specifically, the tank circuit consists of a resonant circuit comprising an inductor L2 and a capacitor C8 connected to each other at each of their respective ends (in parallel). Either the capacitor C8 or the inductor L2 or both may be tunable in order to adjust the frequency of the tank circuit. An inductor L1 acts as an RF choke, with one end of the inductor L1 connected to the output of the voltage regulator U2 and the opposite end of the inductor L1 connected to a first junction of the L2-C8 tank circuit. Preferably, the RF choke inductor L1 is an inductor with a diameter of approximately 0.125 inches and turns on the order of thirty and is connected on a loop of the tank circuit inductor L2. The second and opposite junction of the L2-C8 tank circuit is connected to the collector of BJT 01. The base of the BJT Q1 is also connected through resistor R2 to the output side of the encoder 40. A capacitor C7 is connected to the base of a BJT Q1 and to the first junction of the tank circuit. Another capacitor C9 is connected in parallel with the collector and emitter of the BJT Q1. This capacitor C9 improves the feedback characteristics of the tank circuit. The emitter of the BJT Q1 is connected through a resistor R3 to ground. The emitter of the BJT Q1 is also connected to ground through capacitor C10 which is in parallel with the resistor R3. The capacitor C10 in parallel with the resistor R3 provides a more stable conduction path from the emitter at high frequencies.

The RF generator 50 works in conjunction with a tuned loop antenna 60. In the preferred embodiment, the inductor L2 of the tank circuit serves as the loop antenna 60. Alternatively, the inductor/loop antenna L2 comprises a single rectangular loop of copper wire having an additional smaller loop or jumper 61 connected to the rectangular loop L2. Adjustment of the shape and angle of the smaller loop 61 relative to the rectangular loop L2 is used to increase or decrease the apparent diameter of the inductor L2 and thus tunes the RF transmission frequency of the RF generator 50. In an alternate embodiment, a separate tuned antenna may be connected to the second junction of the tank circuit. Most preferably, the antenna 60 comprises a metallic wire whose length determines the radiated strength of the RF signal. This wire may have one or more “S-bends” to increase the overall length of the antenna. The antenna 60 is affixed, preferably with hot glue, to the top face 70 of the base 70. Attachment of the antenna 60 to the base affects the impedance of the antenna and the characteristics of the radiated signal. A metallic shield 500 may be provided adjacent the antenna 60 on the opposite side 70b of the base 70 to reduce interference with the RF signal.

In operation: The positive voltage output from the voltage regulator U2 is connected the encoder 40 and the RF choke inductor L1. The voltage drives the encoder 40 to generate a coded square wave output, which is connected to the base of the BJT Q1 through resistor R2. When the coded square wave voltage is zero, the base of the BJT Q1 remains de-energized, and current does not flow through the inductor L1. When the coded square wave voltage is positive, the base of the BJT Q1 is energized through resistor R2. With the base of the BJT Q1 energized, current is allowed to flow across the base from the collector to the emitter and current is also allowed to flow across the inductor L1. When the square wave returns to a zero voltage, the base of the BJT Q1 is again de-energized.

When current flows across the choke inductor L1, the tank circuit capacitor C8 charges. Once the tank circuit capacitor C8 is charged, the tank circuit begins to resonate at the frequency determined by the circuit's LC constant. For example, a tank circuit having a 7 picofarad capacitor and an inductor L2 having a single rectangular loop measuring 0.7 inch by 0.3 inch, the resonant frequency of the tank circuit is 310 MHz. The choke inductor L1 prevents RF leakage into upstream components of the circuit (the PIC) because changing the magnetic field of the choke inductor L1 produces an electric field opposing upstream current flow from the tank circuit. To produce an RF signal, charges have to oscillate with frequencies in the RF range. Thus, the charges oscillating in the tank circuit inductor/tuned loop antenna L2 produce an RF signal of preferably 310-430 MHz. As the square wave output of the inverter turns the BJT Q1 on and off, the signal generated from the loop antenna 60 comprises a pulsed RF signal having a duration of 100-250 milliseconds and a pulse width determined by the encoder 40, (typically of the order of 0.1 to 5.0 milliseconds thus producing 20 to 2500 pulses at an RF frequency of approximately 310-430 MHz. The RF generator section 50 is tunable to multiple frequencies. Therefore, not only is the transmitter capable of a great number of unique codes, it is also capable of generating each of these codes at a different frequency, which greatly increases the number of possible combinations of unique frequency-code signals.

The RF generator 50 and antenna 60 work in conjunction with an RF receiver 270. More specifically, an RF receiver 270 in proximity to the RF transmitter 60 (within 300 feet) can receive the pulsed RF signal transmitted by the RF generator 50. The RF receiver 270 comprises a receiving antenna 270 for intercepting the pulsed RF signal (tone). The tone generates a pulsed electrical signal in the receiving antenna 270 that is input to a microprocessor chip that acts as a decoder 280. The decoder 280 filters out all signals except for the RF signal it is programmed to receive, e.g., the signal generated by the RF generator 50. An external power source is also connected to the microprocessor chip/decoder 280. In response to the intercepted tone from the RF generator 50, the decoder chip produces a pulsed electrical signal. The external power source connected to the decoder 280 augments the pulsed voltage output signal developed by the chip. This augmented (e.g., 120VAC) voltage pulse is then applied to a conventional relay 290 for changing the position of a switch within the relay. Changing the relay switch position is then used to turn an electrical device with a bipolar switch on or off, or toggle between the several positions of a multiple position switch. Zero voltage switching elements may be added to ensure the relay 290 activates only once for each depression and recovery cycle of the flextensional transducer element 12.

Electronic Digital Switching System

An electronic digital entry system comprises one or more electroactive devices 12 and keys or a keypad for entry of a digital code or sequence, as well as an circuit for using the electrical energy of the electroactive device(s) 12 and interpretation of the sequence entered into the keypad.

Referring again to FIG. 4: The keypad comprises an overlay pad having a number of alphanumeric keys 321, 322 thereon mounted on a the transmitter 126 or 128. The keypad may have 10 numeric keys corresponding to the numbers 0-9. The keypad may also have alphabetic characters thereon corresponding for example to the letters A-Z or whatever alphabet is used in the particular country. The keypad may also have function keys for commands such as “ENTER”, “LOCK”, “RESET”, “CANCEL”, “BACKSPACE”, “ARM” or the like. Most preferably, the keypad has the numbers 0-9 and the commands “ENTER” and “CANCEL” thereon. Additional commands available may include “ON”, OFF″, “50% ON”, “DIM”, “UNDIM”, “ACTIVATE”, or a selection of toggles switches for selected devices including lights, electrical appliances, door locks, alarm systems, entry systems, fans, electronic devices and the like.

The individual buttons 321, 322 on the keypad 320 are easily depressible buttons that may take a variety of forms. As an example of types of keypad buttons that may be used are flat membrane switches 321, 322, and domed membrane switches 321, 322 and may further include LEDs or the like as indicators of the switch or button state. For example, flat membrane switches 321, 322 comprise a button overlay material of polyester or polycarbonate with circuit connectors installed thereunder and are depressible with an applied force of 70-120 grams. Domed membrane switches 321, 322 have a better sense of touch and may be actuated with an operating force of 150-400 grams. The overlay material comprises a flexible yet durable material such as plastic, polyester or polycarbonate with electrical connectors installed thereunder.

Basically, a membrane switch 321, 322 as its name implies an electrical switch created on a thin film or membrane. They are typically low power with maximum current ratings of around 1/10 of an amp. The circuitry for these devices is often somewhat elaborate since they frequently provide connections for a host of different input functions. Perhaps the most common application for membrane switches 321, 322 is in a keyboard of some type. While not all keyboards are made of flexible materials, a great many are. The most common layouts are matrix type (i.e., rows and columns) and common line connections (i.e., a common trace plus some number of switches). Other structures are possible depending on the needs of the user including integration of electronic circuits, including passives devices, such as resistors, and land patterns for component mounting.

The conductor material used for membrane switches 321, 322 varies by application. Copper and polymer thick film (PTF) inks are the most common choices. Cost is normally a key factor when making the choice. Because of this, a substantial number of membrane switches have screen-printed PTF conductors consisting of metal-filled ink. Obviously, the normally much lower conductivity of printed inks limits the conductivity but they are not normally meant to carry current. Rather they are designed to send a simple signal pulse. Copper is employed when there is need to solder devices to the membrane or higher conductivity is needed, however, conductive adhesives have proven quite acceptable in most applications.

The switch-life of a membrane contact can vary significantly from several thousand to many millions. The life-determining factors are many, and include such matters as materials of construction, contact design, switch travel, and operating conditions among many others.

One of the key elements of membrane switch design is involved in determining tactile feedback. This is that little snap or click that can be felt when a switch is pressed. Determining the right amount of force to be applied (the actuation pressure) is both an art and a science. There are basically two approaches to getting tactile feed back: metal dome contacts and polymer dome contacts. Metal dome tactile switches have spring metal dome over the contact area. When pressed, it snaps down to complete a circuit and snaps back when released. The shape and thickness of the metal (commonly spring stainless steel) will determine actuation force. They offer a long life but are not well suited to use with flex circuits. In contrast, polymer dome switches are embossed into the plastic film overlying the circuit. It is possible to get a good tactile feel from such contact, and though their life expectation is heavily influenced by their use environment, they can still endure millions of cycles. Furthermore, they have the advantage when it comes to cost since they reduce the number of parts, thus assembly time and complexity. Depending on the application, one can opt to not use tactile feedback. To this end, an auditory response method may be employed such as a small beep. Because of their extreme simplicity, these tend to be the lowest cost contacts of all.

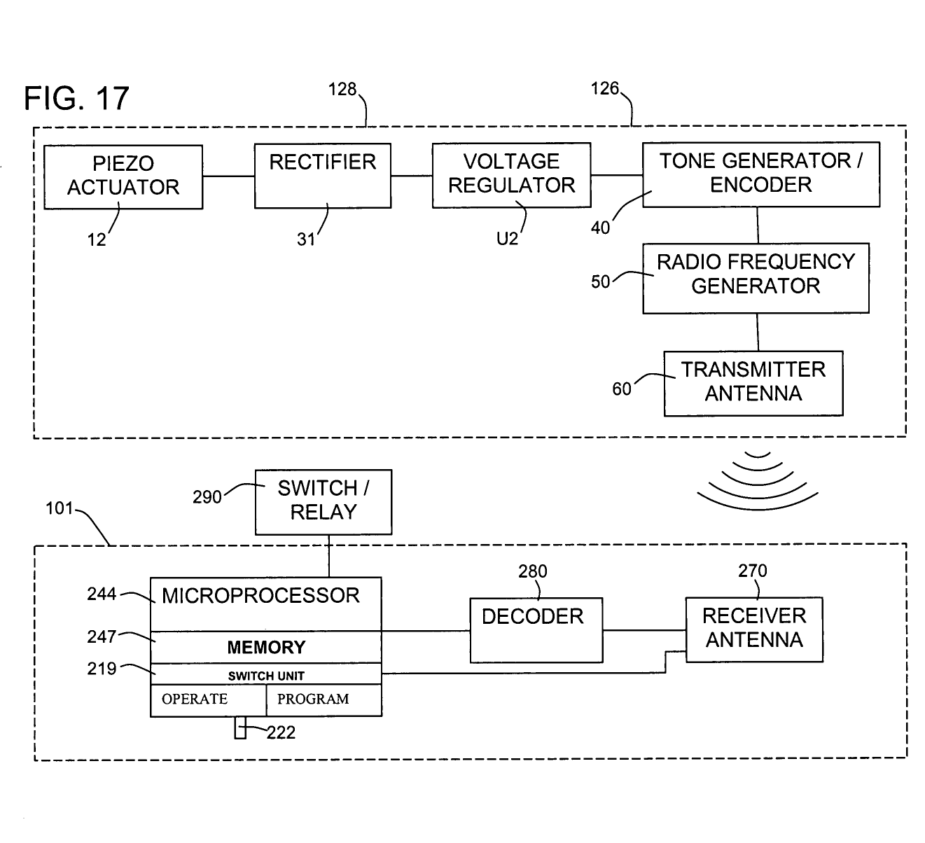

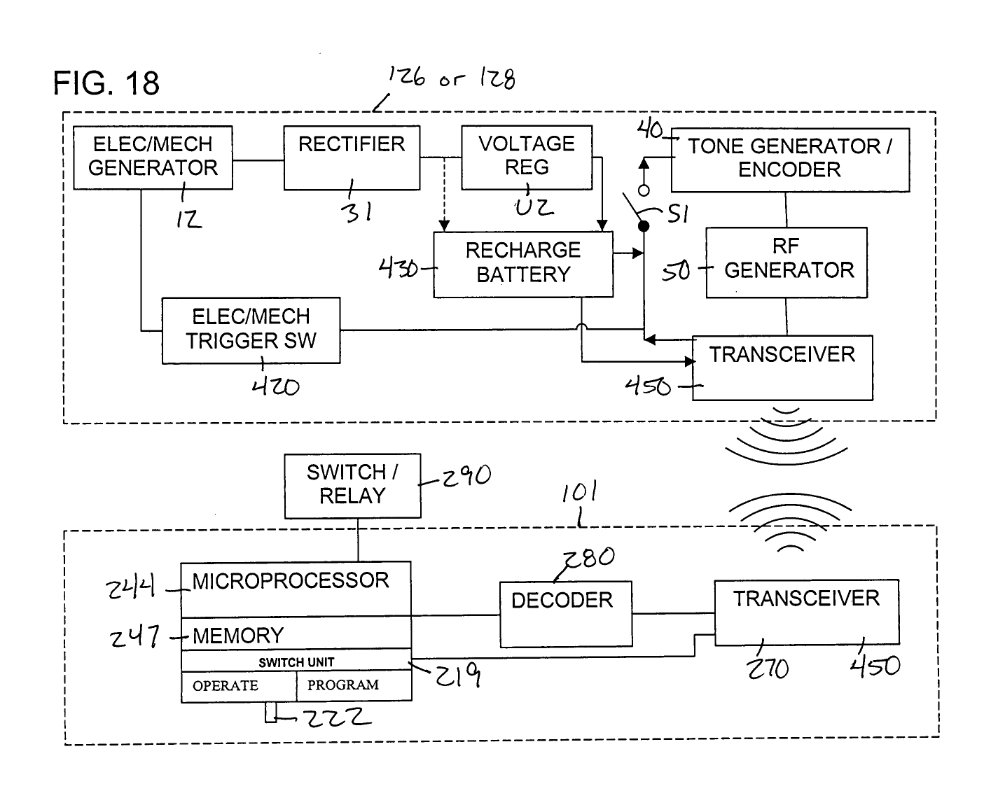

Basic membrane switch contact designs are shown without an over layer in FIGS. 17 and 18. The shorting contact 325 of FIG. 18 on the right is normally attached to a resilient material that holds it off the surface of the interdigitated fingers 326 and 327 when it is not pressed down. The shorting contact 325 of FIG. 17 is a metallic dome situated above concentric electrical traces 328 and 329, and when the dome 325 is pressed contacts at least the outer circular trace 328, and when fully depressed contacts bother the inner 329 and outer 328 traces.

The contact area design is another important and interesting element of a membrane switch. Contact finish can vary. Gold, nickel, silver and even graphite have been used. The layout will vary with the type of contact used. For example, for a shorting contact, interdigitated fingers are often used. However, when a metal dome contact is employed, a central contact with a surrounding ring is frequently seen.

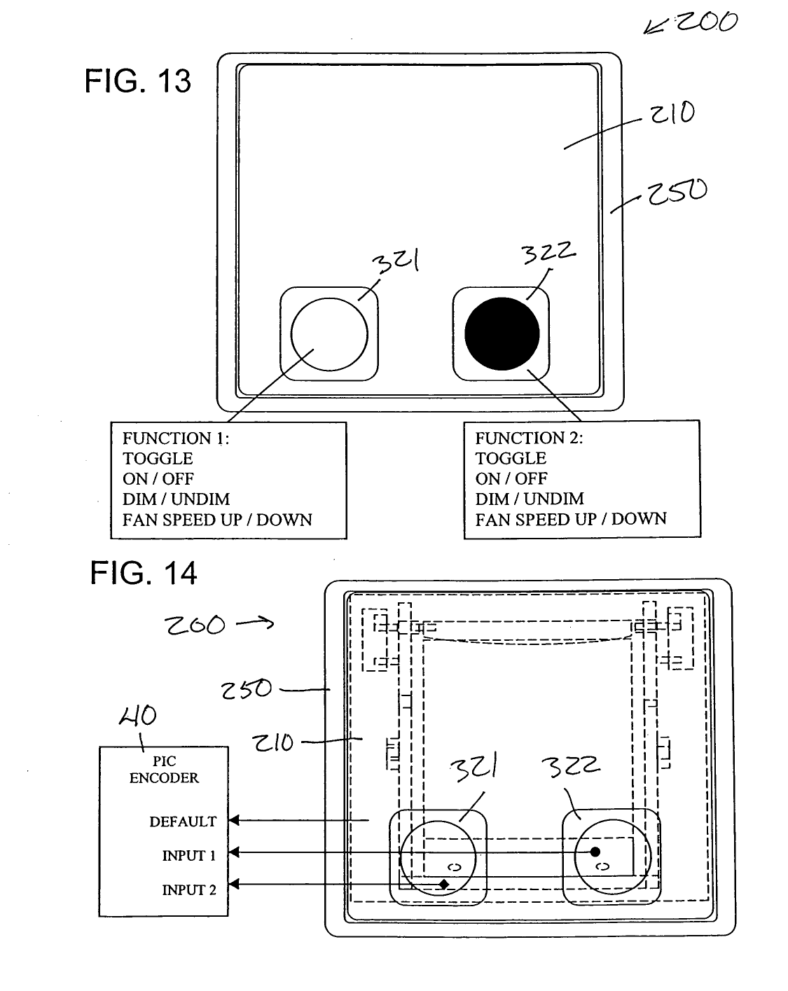

In one embodiment of the invention a polyester or polycarbonate overlay material having twelve switch buttons 321, 322 thereon is used with an individual THUNDER element 12 lying beneath each button. As shown in FIGS. 13-15, alternately an overlay with flat membrane switch buttons 321, 322 may be used above individual THUNDER elements 12. In the preferred embodiment of the invention, the overlay material has twelve domed switch buttons 321, 322 overlying a single large THUNDER element 12. However, either flat or domed membrane switches may be used with either a single or multiple piezoelectric elements thereunder.

The overlay of buttons and the underlying THUNDER element(s) are preferably retained in the face plate section 330 of the keypad assembly. The face plate section 330 of the keypad assembly has one or more recesses 331, 332 therein which retain the overlay material and underlying THUNDER element(s). The face plate section 330 is preferably the same shape as the overlay 320, and more preferably a square plate having a flat surface and a lip around the periphery of the flat surface which forms the recess 331, 332. The recess 331, 332 is suitable for retaining the overlay 320 about its edge between the flat surface of the face plate and the lip. In the embodiment of FIG. 5, the recess 331, 332 is also suitable for retaining two edges of the THUNDER element, and deep enough to allow the edges of the THUNDER element to deeper into the recess when it deforms.

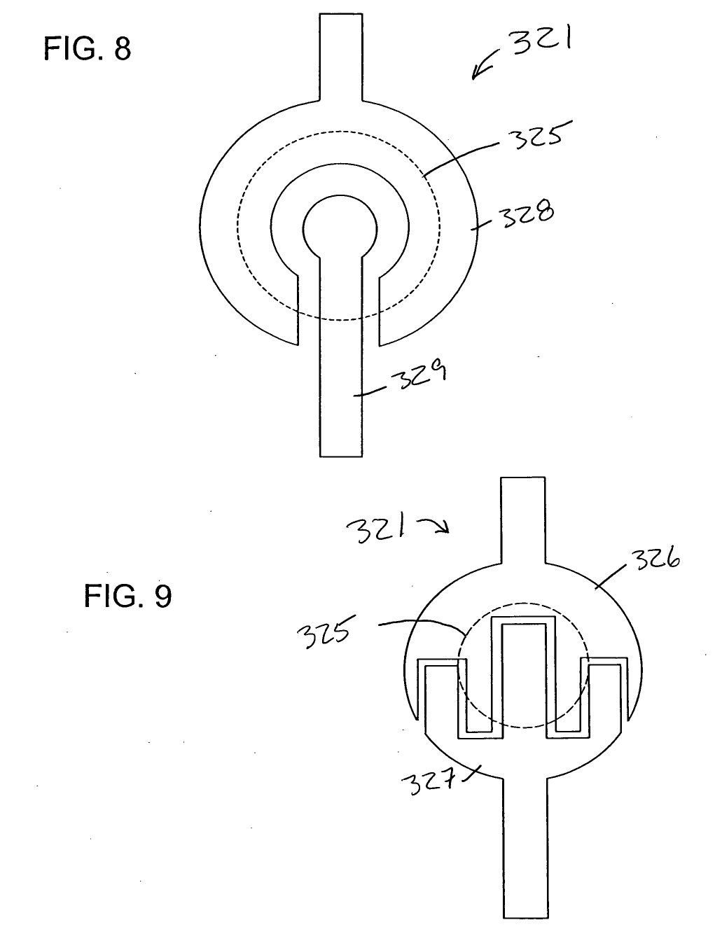

The face plate may also comprise additional recesses for retaining the individual smaller THUNDER elements. The recesses are 331, 332, 335-7 in the flat surface of the face plate and are the substantially the same shape as the THUNDER element retained therein. The shape of the THUNDER button recesses allows them to be retained within the recess yet allows some room for the THUNDER element to extend further thereinto when the THUNDER element is deformed by the pressing of a membrane switch. Preferably, the recess 331, 332, 335-7 retains the edges of the THUNDER element 12 in its neutral arcuate shape and also deep enough to accommodate the THUNDER element in its deformed flattened state. In the embodiment of FIGS. 6 and 8, the face plate has twelve circular recesses in its flat outer surface which retain twelve circular THUNDER elements. The diameter of each recess below the outer surface of the face plate is slightly larger than the diameter of the THUNDER element retained therein and the diameter of each recess at the outer surface of the face plate is slight smaller than the diameter of the THUNDER element retained therein. FIG. 6 shows circular piezo-elements retained in circular recesses, but the elements may also be square, rectangular or a variety of other shapes with recesses accommodating that shape, in order to maximized the amount of power harvested from the deformation of the element.

In operation, when one button 321, 322 is pressed, the THUNDER element 12 underlying the button or buttons is deformed. More specifically, when a button 321 of the keypad 320 of FIG. 4 is pressed, the THUNDER element 12 beneath that button 321 will deform. For one keypad when any button on the keypad 320 is pressed, the whole THUNDER element 12 will deform. Alternately when a button 321 on the keypad 320 is pressed, the underlying THUNDER element 12 will deform.

As previously mentioned, the applied force causes the piezoelectric actuator 12 to deform. By virtue of the piezoelectric effect, the deformation of the piezoelectric element 67 generates an instantaneous voltage between the faces 12a and 12c of the actuator 12, which produces a pulse of electrical energy. Furthermore, when the force is removed from the piezoelectric actuator 12, the actuator 12 recovers its original arcuate shape. This is because the substrate or prestress layers 64 and 68 to which the ceramic 67 is bonded exert a compressive force on the ceramic 67, and the actuator 12 thus has a coefficient of elasticity that causes the actuator 12 to return to its undeformed neutral state. On the recovery stroke of the actuator 12, the ceramic 67 returns to its undeformed state and thereby produces another electrical pulse of opposite polarity. The downward (applied) or upward (recovery) strokes should cause a force over a distance that is of sufficient magnitude to create the desired electrical pulse. The duration of the recovery stroke, and therefore the duration of the pulse produced, is preferably in the range of 5-100 milliseconds, depending on the amount of force applied to the actuator 12.

The electrical signal generated by the actuator 12 is applied to downstream circuit elements via wires 14 connected to the actuator 12. More specifically, a first wire 14 is connected to the electrode 90 which extends into the recess 80 and contacts the electrode 68 on the convex face 12a of the actuator 12. Preferably the wire 14 is connected to the electrode 90 outside of the recess close to the end of the base plate 70 opposite the end having the clamping member 75. A second wire 14 is connected directly to the first prestress layer 64, i.e., the substrate 64 which acts as an electrode on the concave face 12c of the actuator 12.

Referring to FIG. 15-21: The actuator 12 is connected to circuit components in order to generate a signal for actuation of the interface circuit. The actuator 12 is first connected to a rectifier 31. Preferably the rectifier 31 comprises a bridge rectifier 31 comprising four diodes D1, D2, D3 and D4 arranged to only allow positive voltages to pass. The first two diodes D1 and D2 are connected in series, i.e., the anode of D1 connected to the cathode of D2. The second two diodes D3 and D4 are connected in series, i.e., the anode of D3 connected to the cathode of D4. The anodes of diodes D2 and D4 are connected, and the cathodes of diodes D1 and D3 are connected, thereby forming a bridge rectifier. The rectifier is positively biased toward the D2-D4 junction and negatively biased toward the D1-D3 junction. One of the wires 14 of the actuator 12 is electrically connected between the junction of diodes D1 and D2, whereas the other wire 14 (connected to the opposite face of the actuator 12) is connected to the junction of diodes D3 and D4. The junction of diodes D1 and D3 are connected to ground. A capacitor C11 is preferably connected on one side to the D2-D4 junction and on the other side of the capacitor C11 to the D1-D3 junction in order to smooth the rippled voltage and isolate the voltages at each side of the rectifier from each other. Therefore, any negative voltages applied to the D1-D2 junction or the D3-D4 junction will pass through diodes D1 or D3 respectively to ground. Positive voltages applied to the D1-D2 junction or the D3-D4 junction will pass through diodes D2 or D4 respectively to the D2-D4 junction.

The circuit also comprises a voltage regulator U2, which controls magnitude of the input electrical signal downstream of the rectifier 31. The rectifier 31 is electrically connected to a voltage regulator U2 with the D2-D4 junction connected to the Vin pin of the voltage regulator U2 and with the D1-D3 junction connected to ground and the ground pin of the voltage regulator U2. The voltage regulator U2 comprises for example a LT1121 chip voltage regulator U2 with a 3.3 volts DC output. The output voltage waveform is shown in FIG. 10c and comprises a substantially uniform voltage signal of 3.3 volts having a duration of approximately 100-250 milliseconds, depending on the load applied to the actuator 12. The regulated waveform is shown in FIG. 10b. The output voltage signal from the voltage regulator (at the Vout pin) may then be transmitted via another conductor to the relay switch 290, in order to change the position of a relay switch 290 from one position to another.

Preferably however, the output voltage is connected through an encoder 40 to an RF generation section 50 of the circuit.

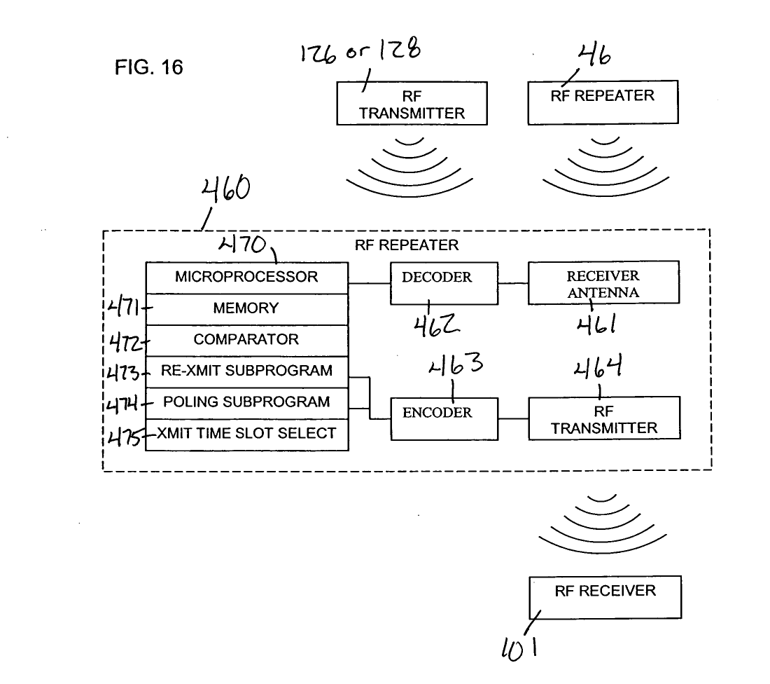

Referring now to FIGS. 15 and 16: The regulated voltage is almost instantaneous and is sufficient to provide power to the keypad 320 and 340 in order to register the contact of each button 321, 322 or command pressed on the keypad 320. Additionally, residual electrical energy (not used by the keypad) is stored in capacitor C15, or in other embodiments a rechargeable battery). As each successive button on the keypad is punched, the capacitor C15 stores more energy, and the logic circuit 340 downstream of the keypad 320 registers which buttons have been actuated. The logic component 340 is typically a simple PIC (Programmable interface controller) which stores one or more acceptable codes (such as access codes and codes which perform different functions or identify specific individuals assigned that code.)

A keypad to register successive button entries for a coded entry system may be disclosed. Input power to the circuit is provided by the output of the voltage regulator. When an acceptable code is entered into the self powered keypad, the keypad circuit or logic component sends an actuation signal to a switching device (such as a transistor) located between the storage device (capacitor or rechargeable battery) and the entry mechanism or other switching device. The switching device is normally in the open position when no code or the wrong code has been entered. After the correct code is entered the logic component sends a signal to the switching device to close. This allows the capacitor/battery to discharge through the switch to the entry mechanism.

The keypad logic circuit components comprise an IC which is a quad 2 input “AND” gate, such as a CMOS 4081. These gates only produce a HIGH output, when BOTH the inputs are HIGH. When the key wired to ‘E’ is pressed, current through R1 and D1 switches Q5 on. The relay energizes; and Q5 is latched on by R8. Thus, the alarm is set by pressing a single key, say one of the two non-numeric symbols.

The circuit will switch off when the 4 keys connected to “A,B,C,D” are pushed in the right order. The circuit works because each gate ‘Stands’ upon its predecessor. If any key other than the correct key is pushed, then gate 1 is knocked out of the stack, and the code entry fails. Pin 1 is held high by R4. This ‘Enables’ gate 1; and when button ‘A’ is pressed, the output at pin 3 will go high. This output does two jobs. It locks itself ‘ON’ through R2 and it ‘Enables’ gate 2, by taking pin 5, high. Now, if ‘B’ is pressed, the output of gate 2, at pin 4 will go high. This output does two jobs. It locks itself ‘ON’ through R3 and it ‘Enables’ gate 3 by taking pin 12 high.

Now, if ‘C’ is pressed, the output of gate 3 will lock itself ‘ON’ through R5 and, by taking pin 8 high, ‘Enable’ gate 4. Pressing ‘D’ causes gate 4 to do the same thing; only this time its output, at pin 10, turns Q4 ‘ON’. This takes the base of Q5 to ground, switching it off and letting the relay drop out.

Any keys not connected to ‘A B C D E’ are wired to the base of Q1. Whenever ‘E’ or one of these other keys is pressed, pin 1 is taken low and the circuit is reset. In addition, if ‘C’ or ‘D’ is pressed out of sequence, then Q2 or Q3 will take pin 1 low and the circuit will reset. Thus nothing happens until ‘A’ is pressed. Then if any key other than ‘B’ is pressed, the circuit will reset. Similarly, after ‘B’, if any key other than ‘C’ is pressed, the circuit will reset. The same reasoning also applies to ‘D’. The Keypad needs to be the kind with a common terminal and a separate connection to each key. On a 12 key pad, look for 13 terminals. The matrix type with 7 terminals will NOT do. Wire the common to R1 and your chosen code to ‘A B C D’. Wire ‘E’ to the key you want to use to switch the alarm on. All the rest go to the base of Q1.

The code can be chosen to include the non-numeric symbols. The number of combinations of codes available is in excess of 10 000 with a 12 key pad. If a more secure code desired, one can add another 4081 and continue the process of enabling subsequent gates. Also one may simply use a bigger keypad with more “WRONG” keys. It is required that the 4k7 resistors protect the junctions while providing enough current to turn the transistors fully on. Capacitors (C1 C2 C3 C4 C5) are there to slow response time and overcome any contact bounce.

Referring to FIG. 15: The entry mechanism comprises a latch pin which maintains the locking mechanism in a normally locked configuration. An electrical signal activates an electromechanical device which remove the latch pin from the lock, allowing the door to be opened. In the simplest embodiment of the invention, the electrical energy discharged from the capacitor is connected to a solenoid. In response to an electrical signal through the coils of the solenoid, the core of the solenoid moves through the center of the coils, pulling the attached latch pin out of the locking mechanism. As an alternative to a solenoid, the electromechanical device may also include one or more additional piezoelectric actuator(s) which bend/contract in response to the electrical discharge from the capacitor. When the piezoelectric element deforms it pulls the attached latch pin out of the locking mechanism.

For extra security these systems may turn off and sound a local alarm after a preset number of wrong combinations. One can put a temporary code in for a baby-sitter or house-keeper and then erase it all by yourself right at the keypad. One can control an electric garage door and unlike the very cheap keypads being sold through the home centers, with this keypad one can have a high security locking system that can't be opened. One can have more than one combination so each person will have a unique code. When controlling an electric lock or strike the relay can be set so it's timed to open or close for a pre-determined period. This is called a momentary closure of the relay. Most keypads can also be set for latching, which means that when the correct code is entered, the relay will fire (open or close). It will remain that way until the code is entered again. With the master code one can erase and add new codes any time. You can hook up more than one unit to control a lock such as one on the outside and one on the inside similar to a double cylinder lock.

Some of these keypads are actually part of a two piece system in that the keypad is attached to a separate small box that contains the electronics. These two part systems are inherently more secure because the box is installed inside in a secure are. The two part systems will specify this. Some applications require a special output format know as Wiegand. The Wiegand output is different from the output of most keypads. Most keypads are made to open or close a relay to activate a lock. A Weigand format keypad will instead produce a certain voltage pattern that will be recognized by the systems electronics. Many of these keypads can also be ordered in the Wiegand format and in addition a very secure 26 bit format, at about the same price as regular keypads.

Referring now to FIG. 14-16: The electrical energy from the capacitor C15 may also be used to energize an RF transmission circuit as in FIG. 15. The RF transmitter transmits a coded RF signal to a receiver, which compares the coded signal to those codes stored in the memory. If a correct code is received the microcomputer then sends a signal to the solenoid or piezo-element to remove the latch pin. The RF transmission circuit and receiver modules are described in further detail below.

### RF Transmission Circuit

Referring again to FIGS. 15-21: The output of the voltage regulator U2 is preferably used to power an encoder 40 or tone generator comprising a programmable interface controller (PIC) microcontroller that generates a pulsed tone. This pulsed tone or code modulates an RF generator section 50 which radiates an RF signal using a tuned loop antenna 60. The signal radiated by the loop antenna is intercepted by an RF receiver 270 and a decoder 280 which generates a relay pulse to activate the relay 290.

The output of the voltage regulator U2 is connected to a PIC microcontroller, which acts as an encoder 40 for the electrical output signal of the regulator U2. More specifically, the output conductor for the output voltage signal (usually 3.3 volts, but can range from 1.7-5.0 volts) is connected to the input pin of the programmable encoder 40. Types of register-based PIC microcontrollers include the eight-pin PIC12C5XX and PIC12C67X, baseline PIC16C5X, midrange PIC16CXX and the high-end PIC17CXX/PIC18CXX. These controllers employ a modified Harvard, RISC architecture that support various-width instruction words. The datapaths are 8 bits wide, and the instruction widths are 12 bits wide for the PIC16C5X/PIC12C5XX, 14 bits wide for the PIC12C67X/PIC16CXX, and 16 bits wide for the PIC17CXX/PIC18CXX. PICMICROS are available with one-time programmable EPROM, flash and mask ROM. The PIC17CXX/PIC18CXX support external memory. The encoder 40 comprises for example a PIC model 12C671. The PIC12C6XX products feature a 14-bit instruction set, small package footprints, low operating voltage of 2.5 volts, interrupts handling, internal oscillator, on-board EEPROM data memory and a deep stack. The PIC12C671 is a CMOS microcontroller programmable with 35 single word instructions and contains 1024×14 words of program memory, and 128 bytes of user RAM with 10 MHz maximum speed. The PIC12C671 features an 8-level deep hardware stack, 2 digital timers (8-bit TMR0 and a Watchdog timer), and a four-channel, 8-bit A/D converter.

The output of the PIC may include square, sine or saw waves or any of a variety of other programmable waveforms. Typically, the output of the encoder 40 is a series of binary square waveforms (pulses) oscillating between 0 and a positive voltage, preferably +3.3 VDC. The duration of each pulse (pulse width) is determined by the programming of the encoder 40. The duration of the complete waveform is determined by the duration of output voltage pulse of the voltage regulator U2. A capacitor C5 is preferably be connected on one end to the output of the voltage regulator U2, and on the other end to ground to act as a filter between the voltage regulator U2 and the encoder 40.

Thus, the use of an IC as a tone generator or encoder 40 allows the encoder 40 to be programmed with a variety of values. The encoder 40 is capable of generating a multiplicity of unique encoded signals by simply varying the programming for the output of the encoder 40. More specifically, the encoder 40 can generate any one of a 32 bit combination of (5 billion or more) possible codes. It is also possible and desirable to have more than one encoder 40 included in the circuit in order to generate more than one code from one actuator or transmitter. Alternately, any combination of multiple actuators and multiple pulse modification subcircuits may be used together to generate a variety of unique encoded signals. Alternately the encoder 40 may comprise one or more inverters forming a series circuit with a resistor and capacitor, the output of which is a square wave having a frequency determined by the RC constant of the encoder 40.

Referring to FIGS. 13-16: The encoder 40 is programmable to generate a different code, dependent upon which of the multiple input connections is energized. The DC output of the voltage regulator U2 and the coded output of the encoder 40 are connected to an RF generator 50 via one or more membrane switches 321, 322 on the keypad or faceplate/deflector 72. When a membrane switch 321, 322 is pressed, it creates electrical contact between the output of the voltage regulator U2 and one of the input pins to the PIC encoder 40. The encoder 40 output signal (code) is dependent upon which input pin has the voltage applied thereto. That is to say, the output signal or code is dependent upon and different for each pin energized by the respective membrane switch that is pressed/closed. For example, when the mechanical deflector is pressed (but not a membrane switch 321 or 322), the encoder is energized and sends a default code to the RF transmitter. However, when a membrane switch 321 depressed, it creates electrical contact from the voltage regulator U2 to a different pin of the encoder 40, thus changing the output of the encoder to a different code from the default code. Likewise, when a different switch 322 depressed, it creates electrical contact from the voltage regulator U2 to a yet another pin of the encoder 40, thus changing the output of the encoder to a third different code from the default code and second codes. These codes can correspond to a variety of functions for electrical appliances that receive the transmitted code such as a light switch, a dimmer, an electrical appliance power source, a security system, a motor controller, a solenoid, a piezoelectric transducer and a latching pin for a locking system. Exemplary functions that are associated with the membrane switches and concomitant coded outputs of the encoder 40 include “TOGGLE”, “ON”, “OFF”, “50% ON”, “DIM”, “UNDIM/BRIGHTEN”, “LOCK”, “UNLOCK”, “SPEED UP”, “SLOW DOWN”, “ACTIVATE”, “RESET” or the like command functions for electrical appliances connected to the receiver.

A capacitor C6 may preferably be connected on one end to the output of the encoder 40, and on the other end to ground to act as a filter between the encoder 40 and the RF generator 50. The RF generator 50 consists of tank circuit connected to the encoder 40 and voltage regulator U2 through both a bipolar junction transistor (BJT) Q1 and an RF choke. More specifically, the tank circuit consists of a resonant circuit comprising an inductor L2 and a capacitor C8 connected to each other at each of their respective ends (in parallel). Either the capacitor C8 or the inductor L2 or both may be tunable in order to adjust the frequency of the tank circuit. An inductor L1 acts as an RF choke, with one end of the inductor L1 connected to the output of the voltage regulator U2 and the opposite end of the inductor L1 connected to a first junction of the L2-C8 tank circuit. Preferably, the RF choke inductor L1 is an inductor with a diameter of approximately 0.125 inches and turns on the order of thirty and is connected on a loop of the tank circuit inductor L2. The second and opposite junction of the L2-C8 tank circuit is connected to the collector of BJT Q1. The base of the BJT Q1 is also connected through resistor R2 to the output side of the encoder 40. A capacitor C7 is connected to the base of a BJT Q1 and to the first junction of the tank circuit. Another capacitor C9 is connected in parallel with the collector and emitter of the BJT Q1. This capacitor C9 improves the feedback characteristics of the tank circuit. The emitter of the BJT Q1 is connected through a resistor R3 to ground. The emitter of the BJT Q1 is also connected to ground through capacitor C10 which is in parallel with the resistor R3. The capacitor C10 in parallel with the resistor R4 provides a more stable conduction path from the emitter at high frequencies.

Referring again to FIGS. 15-21: The RF generator 50 works in conjunction with a tuned loop antenna 60. In the preferred embodiment, the inductor L2 of the tank circuit serves as the loop antenna 60. More preferably, the inductor/loop antenna L2 comprises a single rectangular loop of copper wire having an additional smaller loop or jumper 61 connected to the rectangular loop L2. Adjustment of the shape and angle of the smaller loop 61 relative to the rectangular loop L2 is used to increase or decrease the apparent diameter of the inductor L2 and thus tunes the RF transmission frequency of the RF generator 50. In an alternate embodiment, a separate tuned antenna may be connected to the second junction of the tank circuit.

In operation: The positive voltage output from the voltage regulator U2 is connected the encoder 40 via a default pin and to one or more different pins through one or more respective membrane switches 321, 322. The positive voltage output from the voltage regulator U2 is also connected the RF choke inductor L1. The voltage drives the encoder 40 to generate a coded square wave output (which code depends on the pin energized), which is connected to the base of the BJT Q1 through resistor R2. When the coded square wave voltage is zero, the base of the BJT Q1 remains de-energized, and current does not flow through the inductor L1. When the coded square wave voltage is positive, the base of the BJT Q1 is energized through resistor R2. With the base of the BJT Q1 energized, current is allowed to flow across the base from the collector to the emitter and current is also allowed to flow across the inductor L1. When the square wave returns to a zero voltage, the base of the BJT Q1 is again de-energized.

When current flows across the choke inductor L1, the tank circuit capacitor C8 charges. Once the tank circuit capacitor C8 is charged, the tank circuit begins to resonate at the frequency determined by the circuit's LC constant. For example, a tank circuit having a 7 picofarad capacitor and an inductor L2 having a single rectangular loop measuring 0.7 inch by 0.3 inch, the resonant frequency of the tank circuit is 310 MHz. The choke inductor L1 prevents RF leakage into upstream components of the circuit (the PIC) because changing the magnetic field of the choke inductor L1 produces an electric field opposing upstream current flow from the tank circuit. To produce an RF signal, charges have to oscillate with frequencies in the RF range. Thus, the charges oscillating in the tank circuit inductor/tuned loop antenna L2 produce an RF signal of preferably 310 MHz. As the square wave output of the inverter turns the BJT Q1 on and off, the signal generated from the loop antenna 60 comprises a pulsed RF signal having a duration of 10-250 milliseconds and a pulse width determined by the encoder 40, (typically of the order of 0.1 to 5.0 milliseconds thus producing 20 to 2500 pulses at an RF frequency of approximately 310 MHz. The range of the radiated signal is from 200-1000 MHz and most preferably approximately 430 Mhz. The RF generator section 50 is tunable to multiple frequencies. Therefore, not only is the transmitter capable of a great number of unique codes, it is also capable of generating each of these codes at a different frequency, which greatly increases the number of possible combinations of unique frequency-code signals.

The RF generator 50 and antenna 60 work in conjunction with an RF receiver 101. More specifically, an RF receiver 101 in proximity to the RF transmitter 60 (within 300 feet) can receive the pulsed RF signal transmitted by the RF generator 50. The RF receiver 101 comprises a receiving antenna 270 for intercepting the pulsed RF signal (tone or code). The tone generates a pulsed electrical signal in the receiving antenna 270 that is input to a microprocessor chip that acts as a decoder 280. The decoder 280 filters out all signals except for the RF signal it is programmed to receive, e.g., the signal generated by the RF generator 50. An external power source is also connected to the microprocessor chip/decoder 280. In response to the intercepted code from the RF generator 50, the decoder chip produces a pulsed electrical signal. The external power source connected to the decoder 280 augments the pulsed voltage output signal developed by the chip. This augmented (e.g., 120VAC) voltage pulse is then applied to a conventional relay 290 for changing the position of a switch within the relay. Changing the relay switch position is then used to turn an electrical device with a bipolar switch on or off, or toggle between the several positions of a multiple position switch. Zero voltage switching elements may be added to ensure the relay 290 activates only once for each depression and recovery cycle of the flextensional transducer element 12.

Switch Initiator System with Trainable Receiver

Several different RF transmitters may be used that generate different tones for controlling relays that are tuned to receive that tone. In another embodiment, digitized RF signals may be coded and programmable (as with a garage door opener) to only activate a relay that is coded with that digitized RF signal. In other words, the RF transmitter is capable of generating at least one tone, but is preferably capable of generating multiple tones. Most preferably, each transmitter is programmed with one or more unique coded signals. This is easily done, since programmable ICs for generating the tone can have over 2³⁰ possible unique signal codes which is the equivalent of over 1 billion codes. Most preferably the invention comprises a system of multiple transmitters and one or more receivers for actuating building lights, appliances, security systems and the like. In this system for remote control of these devices, an extremely large number of codes are available for the transmitters for operating the lights, appliances and/or systems and each transmitter has at least one unique, permanent and nonuser changeable code. The receiver and controller module at the lights, appliances and/or systems is capable of storing and remembering a number of different codes corresponding to different transmitters such that the controller can be programmed so as to actuated by more than one transmitted code, thus allowing two or more transmitters to actuate the same light, appliance and/or system.

The remote control system includes a receiver/controller for learning a unique code of a remote transmitter to cause the performance of a function associated with the system, light or appliance with which the receiver/controller module is associated. The remote control system is advantageously used, in one embodiment, for interior or exterior lighting, household appliances or security system. Preferably, a plurality of transmitters is provided wherein each transmitter has at least one unique and permanent non-user changeable code and wherein the receiver can be placed into a program mode wherein it will receive and store two or more codes corresponding to two or more different transmitters. The number of codes which can be stored in transmitters can be extremely high as, for example, greater than one billion codes. The receiver has a decoder module therein which is capable of learning many different transmitted codes, which eliminates code switches in the receiver and also provides for multiple transmitters for actuating the light or appliance. Thus, the invention makes it possible to eliminate the requirements for code selection switches in the transmitters and receivers.

Referring to FIGS. 15-18: The receiver module 101 includes a suitable antenna 270 for receiving radio frequency transmissions from one or more transmitters 126 and 128 and supplies an input to a decoder 280 which provides an output to a microprocessor unit 244. The microprocessor unit 244 is connected to a relay device 290 or controller which switches the light or appliance between one of two or more operation modes, i.e., on, off, dim, or some other mode of operation. One or more switch 222s are mounted on a switch unit 219 connected to the receiver and also to the microprocessor 244. The switch 222 is a two position switch that can be moved between the “operate” and “program” positions to establish operate and program modes. The switch 222 may comprise a two position slider switch, or it may also comprise a push button type switch. In one embodiment of the switch 222, the program is a “learn” mode, and activation of the learning function allows the receiver 101 to enter a code it has received into a memory 247. In another embodiment of the switch 222, the program is an “erase” mode, and activation of the erase function allows the receiver to remove a code it has received from the memory 247. The receiver preferably has two switches 222, corresponding to a “learn” pushbutton and an “erase” pushbutton.

In the invention, each transmitter, such as transmitters 126 and 128, has at least one unique code which is determined by the tone generator/encoder 40 contained in the transmitter. The receiver unit 101 is able to memorize and store a number of different transmitter codes which eliminates the need of coding switches in either the transmitter or receiver which are used in the prior art. This also eliminates the requirement that the user match the transmitter and receiver code switches. Preferably, the receiver 101 is capable of receiving many transmitted codes, up to the available amount of memory locations 247 in the microprocessor 244, for example one hundred or more codes.

When the controller 290 for the light or appliance is initially installed, the switch 222 is moved to the program mode and the first transmitter 126 is energized so that the unique code of the transmitter 126 is transmitted. This is received by the receiver module 101 having an antenna 270 and decoded by the decoder 280 and supplied to the microprocessor unit 244. The code of the transmitter 126 is then supplied to the memory address storage 247 and stored therein. Then if the switch 222 is moved to the operate mode and the transmitter 126 energized, the receiver 270, decoder 280 and the microprocessor 244 will compare the received code with the code of the transmitter 126 stored in the first memory location in the memory address storage 247 and since the stored memory address for the transmitter 126 coincides with the transmitted code of the transmitter 126 the microprocessor 244 will energize the controller mechanism 290 for the light or appliance to energize de-energize or otherwise operate the device.

In order to store the code of the second transmitter 128 the switch 222 is moved again to the program mode and the transmitter 128 is energized. This causes the receiver antenna 270 and decoder 280 to decode the transmitted signal and supply it to the microprocessor 244 which then supplies the coded signal of the transmitter 128 to the memory address storage 247 where it is stored in a second address storage location. Then the switch 222 is moved to the operate position and when either of the transmitters 126 and 128 are energized, the receiver decoder 280 and microprocessor 244 will energize the controller mechanism 290 for the light or appliance to energize de-energize or otherwise operate the device. Alternately, the signal from the first transmitter 126 and second transmitter 128 may cause separate and distinct actions to be performed by the controller mechanism 290.

Thus, the codes of the transmitters 126 and 128 are transmitted and stored in the memory address storage 247 during the program mode after which the system, light or appliance controller 290 will respond to either or both of the transmitters 126 and 128. Any desired number of transmitters can be programmed to operate the system, light or appliance up to the available memory locations in the memory address storage 247. In addition, not all transmitters need be self-powered. That is to say, a battery or AC powered transmitter may be installed that “speaks the same language” as the other transmitters, and as such will transmit a code that the receiver is capable of responding to. All that is necessary for such a powered transmitter is that the regulated input voltage pass through and encoder and RF transmitter circuit that uses the same coding (i.e., unique codes) as well as an RF transmission circuit that is modulated with the code (and any other communications protocols) described further herein below and transmitting at the same frequency and pulsewidth as the other RF transmission circuits described above. Thus, a self-powered system may be augmented by transmitters that are powered through a separate AC or DC voltage.

This invention eliminates the requirement that binary switches be set in the transmitter or receiver as is done in systems of the prior art. The invention also allows a controller to respond to a number of different transmitters because the specific codes of a number of the transmitters are stored and retained in the memory address storage 247 of the receiver module 101.

In yet another more specific embodiment of the invention, each transmitter 126 or 128 contains two or more unique codes for controlling a system, light or appliance. One code corresponds in the microprocessor to the “on” position and another code corresponds in the microprocessor 244 to the “off” position of the controller 290. Alternately, the codes may correspond to “more” or “less” respectively in order to raise or lower the volume of a sound device or to dim or undim lighting for example. Lastly, the unique codes in a transmitter 126 or 128 may comprise four codes which the microprocessor interprets as “on”, “off”, “more” and “less” positions of the controller 290, depending on the desired setup of the switches. Alternatively, a transmitter 126 or 128 may only have two codes, but the microprocessor 244 interprets repeated pushes of “on” or “off” signals respectively to be interpreted as dim up and dim down respectively.

In another embodiment of the invention, receiver modules 101 may be trained to accept the transmitter code(s) in one-step. Basically, the memory 247 in the microprocessor 244 of the receiver modules 101 will have “slots” where codes can be stored. For instance one slot may be for all of the codes that the memory 247 accepts to be turned on, another slot for all the off codes, another all the 30% dimmed codes, etc.

Each transmitter 126 has a certain set of codes. For example one transmitter may have just one code, a “toggle” code, wherein the receiver module 101 knows only to reverse its current state, if it's on, turn off, and if it's off, turn on. Alternatively, a transmitter 126 may have many codes for the complex control of appliances. Each of these codes is “unique”. The transmitter 126 sends out its code set in a way in which the receiver 101 knows in which slots to put each code. Also, with the increased and longer electrical signal that can be generated in the transmitter 126, a single transmission of a code set is achievable even with mechanically produced voltage. As a back-up, if this is not true, and if wireless transmission uses up more electricity than is available, some sort of temporary wired connection (jumper not shown) between each transmitter and receiver target is possible. Although the disclosed embodiment shows manual or mechanical interaction with the transmitter and receiver to train the receiver, it is yet desirable to put the receiver in reprogram mode with a wireless transmission, for example a “training” code.

In yet another embodiment of the invention, the transmitter 126 may have multiple unique codes and the transmitter randomly selects one of the multitude of possible codes, all of which are programmed into the memory allocation spaces 247 of the microprocessor 244.

In yet another embodiment of the invention, the transmitter 126 signal need not be manually operated or triggered, but may as easily be operated by any manner of mechanical force, i.e., the movement of a window, door, safe, foot sensor, etc. and that a burglar alarm sensor might simultaneously send a signal to the security system and a light in the intruded upon room. Likewise, the transmitter 126 may be combined with other apparatus. For example, a transmitter 126 may be located within a garage door opener which can also turn on one or more lights in the house, when the garage door opens.

Furthermore, the transmitters 126, 128 can transmit signals to a central system or repeater which re-transmits the signals by wired or wireless means to lights and appliances. In this manner, one can have one transmitter/receiver set, or many transmitters interacting with many different receivers, some transmitters talking to one or more receivers and some receivers being controlled by one or more transmitters, thus providing a broad system of interacting systems and wireless transmitters. Also, the transmitters and receivers may have the capacity of interfacing with wired communications like SMARTHOME or BLUETOOTH, and ZIGBEE.

It is seen that the present invention allows a receiving system to respond to one of a plurality of transmitters which have different unique codes which can be stored in the receiver during a program mode. Each time the “program mode switch” 222 is moved to the program position, a different storage can be connected so that the new transmitter code would be stored in that address. After all of the address storage capacity has been used additional codes would erase all old codes in the memory address storage before storing a new one.

Referring now to FIGS. 18 and 20-21: While in the preferred embodiment of the invention, the actuation means has been described as from mechanical to electric, it is within the scope of the invention to include batteries in the transmitter to power or supplement the power of the transmitter. For example, long life rechargeable batteries 430 may be included in the transmitter circuitry and may be recharged through the electromechanical transducers 12. These rechargeable batteries 430 may thus provide backup power to the transmitter 50. The circuits illustrated in the figures are the same as those described herein above, with the exception of the addition of rechargeable batteries 430 in the circuit. In the circuit of FIGS. 32 and 34, the ground terminal of the battery is connected to ground and the positive terminal is connected to the output side of the rectifier before the voltage regulator. In the preferred circuit of FIGS. 32 and 35, the ground terminal of the battery is connected to ground and the positive terminal is connected to the output side of the voltage regulator U2 before the transmitter subcircuit 50.

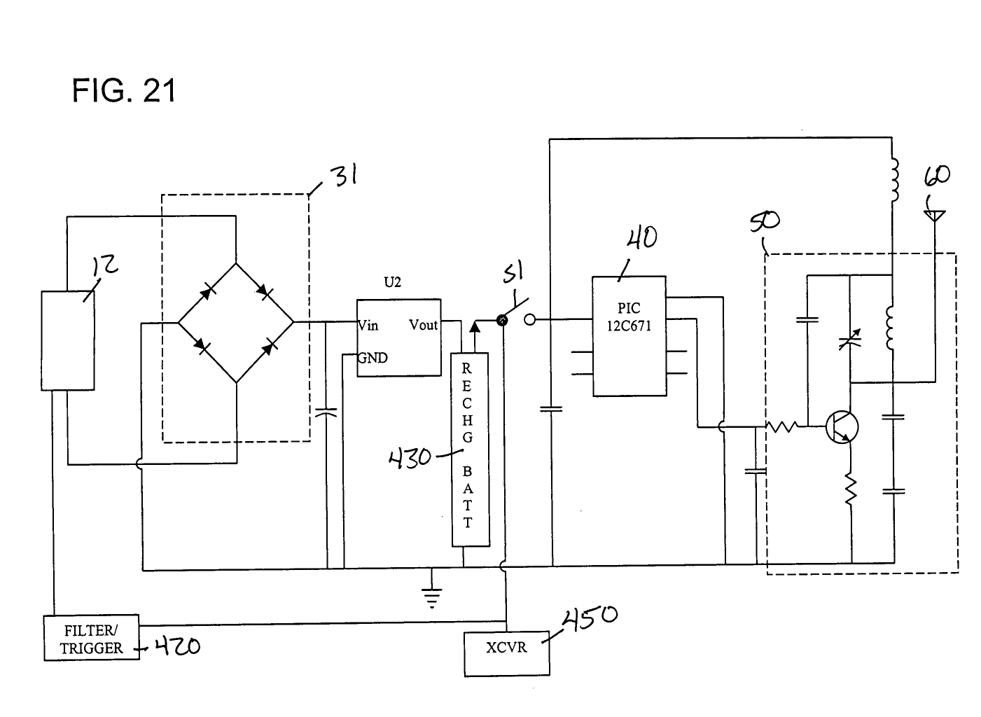

Referring now to FIGS. 18 and 20-21: The circuit of FIG. 21 includes a rechargeable battery as in the circuit of FIG. 18. However, in this circuit, the output of the voltage regulator U2 is connected only to the positive/charging terminal of the rechargeable battery 430, i.e., the voltage regulator U2 output is not connected directly to the input side of the transmitter subcircuit 50. The output of the rechargeable battery 430 is connected to the input side of the transmitter subcircuit through a switch S1. The switch S1 may comprise a transistor. When the switch is closed/energized, electrical power is applied to the transmitter subcircuit. The switch may be energized when the deflection means activates the transducer 12. When the transducer 12 is deflected, an electrical output is produced, most of which is rectified and regulated, and then used of charge the battery 30. A small amount of the electrical power is tapped by a filter/trigger 420 from the transducer 12 (using for example a BJT connected between a grounded resistor and a second resistor between the BJT and the transducer 12), which electrical energy is applied to the switching device in order to electrically connected the battery to the transmitter subcircuit.

Referring again to FIGS. 18 and 20-21: In another embodiment of a self-powered transmitter circuit, the rechargeable battery 430 not only provides power for transmission of a coded signal, but also provides power to a low power consumption receiver 450. In the preferred embodiment, the receiver/transmitter comprises a single transceiver 450. The transceiver 450 is electrically connected to the battery. However, in addition to transmitting in response to a trigger signal from the transducer 12 to energize the switch S1, the transceiver 450 will also transmit in response to the receiver portion of the transceiver's reception of an RF signal. In the preferred embodiment of the transceiver based circuit, when the transceiver 450 receives a coded signal corresponding one or more codes stored in the transmitter PIC (i.e., a polling code), then the transmitter portion of the transceiver 450 will transmit its coded RF signal. The transmitter RF code signal may correspond for example, to a transmission code of its current state for use as or to supplement an error detection code or a verification code. The battery supplemented transceivers 450 are preferably made compatible with present low-cost, very low power consumption, two-way, digital wireless communications standards such as ZIGBEE and BLUETOOTH.

### Single and Multi-Function Switching

In the embodiments of the invention in FIGS. 13-15 pressure is applied directly to the actuator 12 by pushing on (mechanically activating) membrane switches or a keypad on a faceplate or button 210. The membrane switches comprise alphanumeric keys 321, 322 mounted on the top face 210a of the button. The membrane switches 321, 322 may also have function keys for commands written thereon or symbolically represented for commands such as “ENTER”, “LOCK”, “RESET”, “CANCEL”, “BACKSPACE”, “ARM”, “CANCEL”, “TEST” or the like. Additional commands available may include “ON”, OFF″, “DIM”, “UNDIM”, “ACTIVATE”, “50% ON” or a selection of toggles switches for selected devices including lights, electrical appliances, door locks, sensors, alarm systems, entry systems, fans, emergency lighting, electronic devices and the like. These command functions are preferably represented by a symbol (such as a fan, a cycle symbol, or a dark or light dot) corresponding to a function rather than the actual word.

The individual buttons 321, 322 are easily depressible buttons that may take a variety of forms. As an example of types of keypad buttons that may be used are flat membrane switches 321, 322 and domed membrane switches 321, 322 and may further include LEDs or the like as indicators of the switch or button state. For example, flat membrane switches 321, 322 comprise a button overlay material 323 (on which is printed the alphanumeric or other command symbol) of polyester or polycarbonate with circuit connectors installed thereunder and are depressible with an applied force of 70-120 grams. Domed membrane switches 321, 322 have a better sense of touch and may be actuated with an operating force of 150-400 grams. The overlay 323 material comprises a flexible yet durable material such as plastic, polyester or polycarbonate with electrical connectors (such as in FIGS. 13-14) installed thereunder.

Basically, a membrane switch 321, 322 as its name implies an electrical switch created on a thin film or membrane. They are typically low power with maximum current ratings of around 1/10 of an amp. The circuitry for these devices is often somewhat elaborate since they frequently provide connections for a host of different input functions.

The most common application for membrane switches 321, 322 is in a keyboard of some type. While not all keyboards are made of flexible materials, a great many are. The most common layouts are matrix type (i.e., rows and columns) and common line connections (i.e., a common trace plus some number of switches). Other structures are possible depending on the needs of the user including integration of electronic circuits, including passives devices, such as resistors, and land patterns for component mounting.

The conductor material used for membrane switches 321, 322 varies by application. Copper and polymer thick film (PTF) inks are the most common choices. Cost is normally a key factor when making the choice. Because of this, a substantial number of membrane switches have screen-printed PTF conductors consisting of metal-filled ink. Obviously, the normally much lower conductivity of printed inks limits the conductivity but they are not normally meant to carry current. Rather they are designed to send a simple signal pulse. Copper is employed when there is need to solder devices to the membrane or higher conductivity is needed, however, conductive adhesives have proven quite acceptable in most applications. The switch-life of a membrane contact can vary significantly from several thousand to many millions. The life-determining factors are many, and include such matters as materials of construction, contact design, switch travel, and operating conditions among many others.

One of the key elements of membrane switch design is involved in determining tactile feedback. This is that little snap or click that can be felt when a switch is pressed. Determining the right amount of force to be applied (the actuation pressure) is both an art and a science. There are basically two approaches to getting tactile feed back: metal dome contacts and polymer dome contacts. Metal dome tactile switches have spring metal dome over the contact area. When pressed, it snaps down to complete a circuit and snaps back when released. The shape and thickness of the metal (commonly spring stainless steel) will determine actuation force. They offer a long life but are not well suited to use with flex circuits. In contrast, polymer dome switches are embossed into the plastic film overlying the circuit. It is possible to get a good tactile feel from such contact, and though their life expectation is heavily influenced by their use environment, they can still endure millions of cycles. Furthermore, they have the advantage when it comes to cost since they reduce the number of parts, thus assembly time and complexity. Depending on the application, one can opt to not use tactile feedback. To this end, an auditory response method may be employed such as a small beep. Because of their extreme simplicity, these tend to be the lowest cost contacts of all.

Basic membrane switch contact designs are shown without an overlay in FIGS. 8-9. The contact area design is another important and interesting element of a membrane switch. Contact finish can vary. Gold, nickel, silver and even graphite may be used. The layout will vary with the type of contact used. For example, for a shorting contact, interdigitated fingers are often used. However, when a metal dome contact is employed, a central contact with a surrounding ring is frequently seen. The shorting contact 325 of FIG. 9 on the right is normally attached to a resilient material that holds it off the surface of the interdigitated fingers 326 and 327 when it is not pressed down. The shorting contact 325 of FIG. 8 is a metallic dome situated above concentric electrical traces 328 and 329, and when the dome 325 is pressed it contacts at least the outer circular trace 328, and when fully depressed contacts bother the inner 329 and outer 328 traces.

Referring now to FIGS. 14-15 and 19: The encoder 40 is programmable to generate a different code, dependent upon which of the multiple input connections is energized. The DC output of the voltage regulator U2 and the coded output of the encoder 40 are connected to an RF generator 50 via one or more membrane switches 321, 322 on the keypad 320 or faceplate/deflector 72. When a membrane switch 321, 322 is pressed, it creates electrical contact between the output of the voltage regulator U2 and one of the input pins to the PIC encoder 40. The encoder 40 output signal (code) is dependent upon which input pin has the voltage applied thereto. That is to say, the output signal or code is dependent upon and is different for each pin energized by the respective membrane switch that is pressed/closed. For example, when the mechanical deflector is pressed (but not a membrane switch 321 or 322), the encoder is energized and sends a default code to the RF transmitter. However, when a membrane switch 321 depressed, it creates electrical contact from the voltage regulator U2 to a different pin of the encoder 40, thus changing the output of the encoder to a different code from the default code. Likewise, when a different switch 322 depressed, it creates electrical contact from the voltage regulator U2 to a yet another pin of the encoder 40, thus changing the output of the encoder to a third code different from the default code and second code. These codes can correspond to a variety of functions for electrical appliances that receive the transmitted code such as a light switch, a dimmer, an electrical appliance power source, a security system, a motor controller, a solenoid, a piezoelectric transducer and a latching pin for a locking system. Exemplary functions that are associated with the membrane switches and concomitant coded outputs of the encoder 40 include “TOGGLE”, “ON”, “OFF”, “50% ON”, “DIM”, “UNDIM/BRIGHTEN”, “LOCK”, “UNLOCK”, “SPEED UP”, “SLOW DOWN”, “ACTIVATE”, “RESET”, “TEST” or the like command functions for electrical appliances connected to the receiver.

In operation: The positive voltage output from the voltage regulator U2 is connected the encoder 40 via a default pin and to one or more different pins through one or more respective membrane switches 321, 322. The positive voltage output from the voltage regulator U2 is also connected the RF choke inductor L1. The voltage drives the encoder 40 to generate a coded square wave output (which code depends on the pin energized), which is connected to the base of the BJT Q1 through resistor R2. When the coded square wave voltage is zero, the base of the BJT Q1 remains de-energized, and current does not flow through the inductor L1. When the coded square wave voltage is positive, the base of the BJT Q1 is energized through resistor R2. With the base of the BJT Q1 energized, current is allowed to flow across the base from the collector to the emitter and current is also allowed to flow across the inductor L1. When the square wave returns to a zero voltage, the base of the BJT Q1 is again de-energized.

Several different RF transmitters 126, 128 may be used that generate different codes for controlling relays that are trained to receive that code. In another embodiment, digitized RF signals may be coded and programmable (as with a garage door opener) to only activate a relay that is coded with that digitized RF signal. In other words, the RF transmitter is capable of generating at least one code, but is preferably capable of generating multiple codes. Most preferably, each transmitter is programmed with one or more unique coded signals. This is easily done, since programmable ICs for generating the code can have over 2³⁰ possible unique signal codes which is the equivalent of over 1 billion codes. Most preferably the invention comprises a system of multiple transmitters and one or more receivers for actuating building lights, appliances, security systems and the like. In this system for remote control of these devices, an extremely large number of codes are available for the transmitters for operating the lights, appliances and/or systems and each transmitter has at least one unique, permanent and non-user changeable code. The receiver and controller module at the lights, appliances and/or systems is capable of storing and remembering a number of different codes corresponding to different transmitters (or different function buttons/membrane switches on a single transmitter) such that the controller can be programmed so as to be actuated by more than one transmitted code, thus allowing two or more transmitters to actuate the same light, appliance and/or system.

The remote control system includes a receiver/controller for learning one or more unique codes of a remote transmitter to cause the performance of a function associated with the system, light or appliance with which the receiver/controller module is associated. The remote control system is advantageously used, in one embodiment, for interior or exterior lighting, household appliances or security system. Preferably, a plurality of transmitters is provided wherein each transmitter has at least one unique and permanent non-user changeable code and wherein the receiver can be placed into a program mode wherein it will receive and store two or more codes corresponding to two or more different transmitters. The number of codes which can be programmed into transmitters can be extremely high as, for example, greater than one billion codes. The receiver has a decoder module therein which is capable of learning many different transmitted codes, which eliminates code switches (dipswitches) in the receiver and also provides for multiple transmitters for actuating the light or appliance. Thus, the invention makes it possible to eliminate the requirements for code selection switches in the transmitters and receivers.

Referring to FIGS. 15 and 17-18: The receiver module includes an antenna 270 for receiving radio frequency transmissions from one or more transmitters 126 and 128 and supplies a received RF signal as an input to a decoder 280 which provides an output to a microprocessor unit 244. The microprocessor unit 244 is connected to a relay device 290 or controller which switches the light or appliance between one of two or more operation modes, i.e., on, off, dim, or some other mode of operation. A switch 222 is mounted on a switch unit 219 connected to the receiver and also to the microprocessor 244. The switch 222 is a two position switch that can be moved between the “operate” and “program” positions to establish operate and program modes.

In the invention, each transmitter, such as transmitters 126 and 128, has at least one unique code which is determined by the tone generator/encoder 40 contained in the transmitter. The receiver unit 101 is able to memorize and store a number of different transmitter codes which eliminates the need of coding switches in either the transmitter or receiver which are used in the prior art. This also eliminates the requirement that the user match the transmitter and receiver code switches. Preferably, the receiver 101 is capable of receiving many transmitted codes, up to the available amount of memory locations 247 in the microprocessor 244, for example one hundred or more codes.

When the controller 290 for the light or appliance is initially installed, the switch 222 is moved or pressed to initiate the program mode and the first transmitter 126 is energized so that the unique code of the transmitter 126 is transmitted. This is received by the receiver module 101 having an antenna 270 and decoded by the decoder 280 and supplied to the microprocessor unit 244. The code of the transmitter 126 is then supplied to the memory address storage 247 and stored therein. Then if the switch 222 is moved to the operate mode and the transmitter 126 energized, the receiver 270, decoder 280 and the microprocessor 244 will compare the received code with the code of the transmitter 126 stored in the first memory location in the memory address storage 247 and since the stored memory address for the transmitter 126 coincides with the transmitted code of the transmitter 126 the microprocessor 244 will energize the controller mechanism 290 for the light or appliance to energize de-energize or otherwise operate the device.

In order to store the code of the second transmitter 128 the switch 222 is moved (or pressed) again to the program mode and the transmitter 128 is energized. This causes the receiver antenna 270 and decoder 280 to decode the transmitted signal and supply it to the microprocessor 244 which then supplies the coded signal of the transmitter 128 to the memory address storage 247 where it is stored in a second address storage location. Then the switch 222 is moved to the operate position and when either of the transmitters 126 and 128 are energized, the receiver antenna 270, decoder 280 and microprocessor 244 will energize the controller mechanism 290 for the light or appliance to energize de-energize or otherwise operate the device. Alternately, the signal from the first transmitter 126 and second transmitter 128 may cause separate and distinct actions to be performed by the controller mechanism 290.

Thus, the codes of the transmitters 126 and 128 are transmitted and stored in the memory address storage 247 during the program mode after which the system, light or appliance controller 290 will respond to either or both of the transmitters 126 and 128. Any desired number of transmitters can be programmed to operate the system, light or appliance up to the available memory locations in the memory address storage 247.

### Low Voltage Receiver

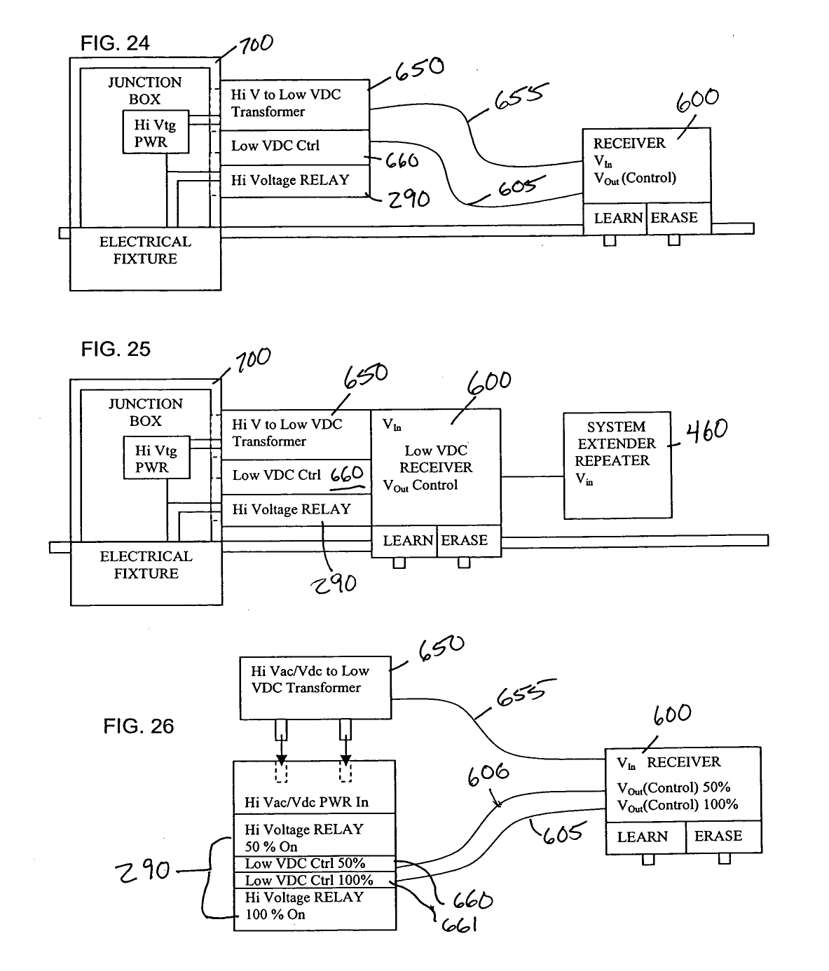

Referring to FIGS. 24-27: In one embodiment of a low voltage receiver 600, all relay and receiver components are enclosed within a unitary package. In the preferred embodiment, a low voltage receiver 600 (operating under 60VDC and preferably 12-24 VDC, and therefor not subject to UL requirements) is separate from the high voltage components (such as the AC/DC transformer 650 and relay 290 which operate on and/or switch 110/230/277/347 VAC or greater, and DC voltages above 60 VDC). High voltage (switched and transformed) components comply with UL packaging requirements and are self-contained and insulated, but are adapted to be connected to conventional junction boxes by nippled or threaded connectors.

Preferably the self-contained relay 290 connects into a junction box 700 with threaded connectors allowing the relay control wires 605, 606 to enter through the hollow fitting into the junction box for wiring. The transformer 650, e.g., 120/277VAC to 24VDC, may be contained within the same enclosure as the relay, and the transformer wires into the junction box through the same connector. Alternately, the transformer 650 may be self-contained within its own separate enclosure and may further be connected by plug-in or threaded electrical connectors. The self-contained transformer 650 may be selectable from a wide variety of input AC or DC voltages and output DC voltages, and connectable in a like manner (by nippled or threaded connectors) to the relay 290 portion or to the junction box.

The operating voltage connection of the low voltage receiver 600 is connected via the wire(s) 655 (or may be directly connected) to the output of the Hi-Low voltage transformer which transforms the input line (AC or DC) voltage to a DC voltage under 60 VDC. The output of the low voltage receiver 600 (which is also a low voltage switching signal under 60 VDC) is connected via wire(s) 605, 606 to the input of the low voltage relay controller 660. The low voltage relay controller 660 generates the signal that switches the higher switched voltage, i.e., the same voltage that has been transformed, or separate high switched voltage. The relay 290 also isolates the DC receiver 600 from the switched voltage.

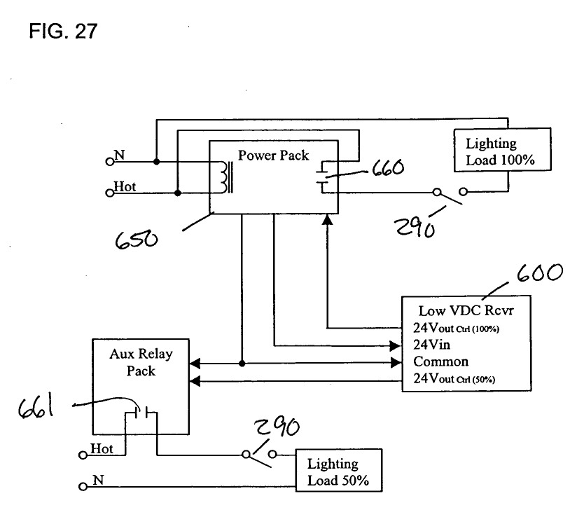

Referring to FIGS. 26-27: The receiver 600 also preferably has the capability of having multiple/bifurcated outputs, i.e., “ALL ON”, “ALL OFF” and “50% ON” for controlling the lightning levels in buildings where full lighting loads and lower lighting loads are desirable, i.e., for energy conservation in lighting. The receiver 600 may also have the capability of resetting an attached sensor, i.e, a smoke alarm or a security system. The relay 290 controlled by the low voltage receiver 600 and controller 660 also has the ability to switch between 3 or more positions corresponding to those command functions. Alternately, the multiple outputs of the receiver may be connected to two or more relay controllers 660, 661.

Because the receiver 600 uses a low operating voltage to generate switching signals, it may be easily located for accessibility and maximum reception. That is to say, when a receiver is co-located with the switched relay as in FIG. 25, it may be in a location that has a hostile RF environment, such as proximity to RF noise makers and interference sources such as electronic ballasts, dimmers, and other circuit components with high EMI or line noise, or behind metallic obstructions. By placing the receiver a distance away from the noise sources as in FIG. 24, reception reliability may be increased. It may be further increased because reception reliability may be maximized by placement of the receiver in a central area which may not correspond with the location of the relay to be switched. Furthermore, the receiver may be installed in a wall or ceiling such that the receiver operating switches (i.e., program, erase and on/off indicator LEDs) are visible and easily accessible. This placement of the receiver allows ease in training/programming/reprogramming and troubleshooting the receiver as well as providing an immediate visible indication of the receiver status.

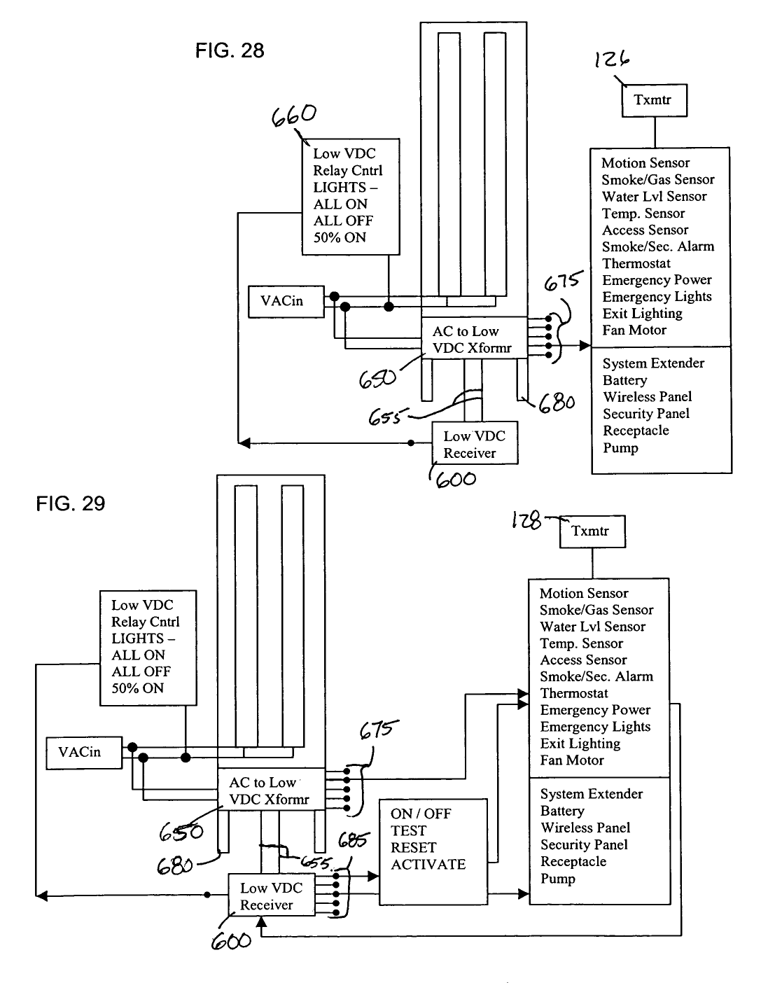

Referring to FIGS. 28-29: In another embodiment of the present invention, the low voltage transformer is located within or packaged with the lighting fixture. The AC line voltage into the lighting fixture is also routed to a transformer 650 that steps the voltage (120/230/277/347VAC) down to a low DC voltage preferably under 60 VDC and most preferably 12-24 VDC. The low VDC transformer 650 preferably has multiple outputs 675 for connection to a variety of low voltage devices such as a receiver 600, lights, a battery, sensor, alarm, control panel, motor controller or other low voltage electrical device.

The lighting fixture also preferably has a mounting area or socket 680 for attachment and retention of a low voltage receiver 600 as well as connection of the receiver to one of the outputs of the low voltage transformer 650. The low voltage receiver 650, which may be wired to the transformer 650 or plugged into a socket 680 is adapted to selectably control the lighting level of the lighting fixture to which it is attached. The low voltage receiver 600 is connected to a low voltage relay controller 660 which is connected to one or more relays 290 that control the lights within the fixture. The relay controller is preferably a 3-position controller that can vary the lighting level from “ALL ON”, “ALL OFF” and “50% ON”. Alternately, the receiver 600 may only be connected to one of the lights within the fixture. In this manner, the light fixture (and receiver) may be energized using the already wired conventional AC wall switch. A transmitter may be used to energize and de-energize the receiver, thereby turning on or off one of the two lights (or half of the total lights) within a lighting fixture.

In the embodiment of FIG. 28, the low voltage transformer 650 has multiple outputs 675 by which power can be directed to low voltage components such as one or more of a motion sensor, a smoke or other gas sensor, water level sensor, temperature sensor, access sensor, a smoke or security alarm, thermostat, emergency power, emergency lights, exit lighting, fan motor, a system extender, battery, wireless panel, security panel, electrical receptacle or a pump. The transformer 650 output may also be connected to a low voltage transmitter 126 which is connected to any of the aforementioned low voltage devices. The transmitter 126 is adapted to transmit the status of the electrical device to which it is attached. The status may be displayed at a central control or display panel. The transmitter code is programmed into the low voltage receiver 600 so that the receiver may send an appropriate command signal to the device which it controls. For example, if the security sensor detects a breach, the transmitter sends a security code to the receiver which sets of an alarm or locks doors or turns on appropriate lighting fixtures. Likewise, if smoke or gas is detected, the sensor signal is transmitted and the receiver activates appropriate lighting levels and/or alarms. If a water level sensor code is transmitted, the receiver may turn on a pump. If a motion or occupancy sensor detects a no motion in an area, the lights in that area can be turned off or to half intensity. If a code is sent indicating an interruption in power, the battery backup may be activated and emergency lighting or health and safety sensors may be provided with an uninterrupted backup power supply. If a thermostat setting is changed, the receiver can vary the setting of the heating and cooling elements. All of these actions are easily within the capability of the receiver programming.

In the embodiment of FIG. 29, the low voltage transformer 650 may also have multiple outputs 675 by which power can be directed to low voltage components, but the receiver 600 also has multiple outputs 685 for one or more of a motion sensor, a smoke or other gas sensor, water level sensor, temperature sensor, access sensor, a smoke or security alarm, thermostat, emergency power, emergency lights, exit lighting, fan motor, a system extender, battery, wireless panel, security panel, electrical receptacle or a pump. The transformer and/or receiver power output may also be connected to a low voltage transmitter which is connected to any of the aforementioned low voltage devices. The transmitter is adapted to transmit the status of the electrical device to which it is attached. The status may be displayed at a central control or display panel. The transmitter code is programmed into the low voltage receiver so that the receiver may send an appropriate command signal to the device which it controls. Alternately, the devices controlled may send an alert or status signal back to the receiver with one or more wires. For example, if the security sensor detects a breach, the transmitter or sensor sends a security code to the receiver which sets off an alarm or locks doors or turns on appropriate lighting fixtures. Likewise, if smoke or gas is detected, the sensor signal is transmitted (via transmitter or wire) and the receiver activates appropriate lighting levels and/or alarms. If a water level sensor code is transmitted, the receiver may turn on a pump. If a motion or occupancy sensor detects a no motion in an area, the lights in that area can be turned off or to half intensity. If a code is sent indicating an interruption in power, the battery backup may be activated and emergency lighting or health and safety sensors may be provided with an uninterrupted backup power supply. If a thermostat setting is changed, the receiver can vary the setting of the heating and cooling elements. All of these actions are easily within the capability of the receiver programming.

The receiver is also capable of sending a variety of coded signal to the devices to which it is attached. For example a transmission of a “test” test code may disconnect lighting, sensor or alarm fixtures in order to test the battery backup for the emergency lighting, sensor or alarms. Another “test” code may perform a functional test of the alarm or sensors, and a “reset” code may deactivate an alarm that was set off for a test or otherwise (i.e., inadvertently by a power surge). Sending and “activate” code may engage a pump or fan motor for smoke and water clearance or it may switch motion sensors between an occupancy and a security/alarm mode. With the thermostat function of the receiver, the receiver may receive a temperature status to activate or deactivate heating and cooling devices. Obviously, On and Off control of all these devices is also a function that con be performed through the receiver. Also, the low voltage system extender increases reliability of reception of signals transmitted by the transmitter(s). Furthermore, the battery backup can provide power not only to emergency and health and safety devices in the building, but may also provide backup power to the receiver and/or system extender in order to provide backup power for activating and deactivating any device that the receiver is connected to.

In the preferred embodiment of the low voltage receiver with multiple outputs 685, the output wire(s) and receiver output connections for controlling the low power devices are color coded. For example, the fire/smoke alarm output port of the receiver may be colored red, and is adapted to receive red tipped wires from the smoke detector/fire alarm. The output ports and cooperating wire fittings adapted to be received therein may be specially shaped (i.e., circular, square, triangular, hexagonal) so that they can only be received in the appropriate port. Each of these ports is also specialized in that each port only has access to command functions within the receiver appropriate to that device. For example, the fire alarm port may only have test, reset and activate signals sent therefrom, but does not have an off signal which would remove the fire alarm from the power circuit. Again, such programming of command function outputs to specific output ports of the receiver is easily done on the PIC chip within the receiver. The output ports for connection to low power devices have fitting suitable for retention of the wires to the low voltage devices and may comprise spring loaded fittings, tensioned clips, friction fittings, push in and quick release fitting.

### System Extender

In the present invention a self-powered switch initiation system uses an electroactive element to develop an oscillating electrical signal. The accompanying circuitry is designed to work with that signal and generate a coded RF transmission. The system comprises one or more transmitters, receivers and repeaters that use that coded RF transmission to communicate specific electronic codes to each other to increase system range and reliability.

Referring to FIG. 16: To further enhance the system, the system uses a system of one or more repeaters/transceivers 460 to increase transmission range and reliability of reception of transmitted signals. The transceiver 460 comprises a receiver 461 and a transmitter 464, which are powered by an external power source, such as conventional 120VAC, 220VAC or 6-50 VDC (from a low voltage output of the transformer or the low voltage receiver). Since the transceiver 460 has an external power source, the receiver sensitivity is increased, thereby extending the reception range of the receiver portion of the transceiver. Also, since the transceiver has an external power source, the transmitter power is increased, thereby increasing the transmission range and the number of transmissions possible from the transmitter portion of the transceiver.

The codes used by the transmitter and accepted for performing an action at the receiver or transceiver are preferably a 32-bit binary code comprising a unique (i.e., one of 2²⁴ to 2³⁰ combinations) transmitter identification code and a function code. These codes are programmed into the internal PIC/logic component during manufacture of the transmitter and are not changeable by the user of the device, although the user may have the ability to select one from a multiplicity of codes by using membrane switches or a selector device. The transmitters and transceivers are also programmed to send out a handshake code to establish the “language” and timing of signals among the transceivers and receivers.

Referring to FIGS. 16 and 22-23: The transmitters and transceivers use a “handshake” procedure to establish communications with other receivers and/or transceivers. The first code transmitted is the alternating portion of the handshake code which is a 4-20 bits of alternating ones (1) and zeros (0), each bit having defined a duration or pulsewidth. The number of bits as well as the pulsewidth defines the “language” that receivers and transceivers are programmed to accept before performing their desired function. Receivers and transceivers are programmed to respond only if they receive a certain number of those 1s and 0s at the defined pulswidth (say 12-15 out of 20). This handshake procedure also comprises a defined “dead time” after the number of alternating bits has been received. The typical handshake routine takes from 2-12 milliseconds. Upon receipt of the minimum number of bits in the alternating portion of the handshake, the receiver or transceiver is programmed to expect a time period having no transmission signal there, for example 6 to 8 cycles of the pulsewidth defined by the alternating portion. Upon receipt of an appropriate “handshake”, the receiver or transceiver will then listen to an incoming coded signal to determine whether receiver action or transceiver retransmission is necessary as defined by the internal programming of the receiver or transceiver.

In a system comprising two or more transceivers 460, the transceivers use a poling operation, which is programmed into each transceiver at manufacture, to assign channels or time slots for each transceiver. This operation prevents two transceivers from transmitting simultaneously or near simultaneously, thereby preventing out-of-phase transmission from interfering with each other. When a first transceiver is initially connected to a power source, the transceiver sends a signal corresponding to a setup mode, thereby “announcing” its presence in the system. This setup signal may correspond to the unique identification code of that transceiver, or a timing/handshake signal, or to a time slot/channel that that transceiver is assigned, or any combination of ID, handshake, timing or channel information. Alternately, and most preferably, rather than the “announcement code” being transmitted automatically upon connection to a power source, the transceivers have a setup mode which is activated by the user. The setup mode may be selected by moving a switch or pushing a button, for example.

Other transceivers 460 in the system are programmed to respond to this “announcement” signal with their own announcement code, containing at least the time slot to which the other transceivers are assigned. If the first transceiver does not receive a response from other transceivers in response to its “announcement” poling signal, that transceiver assigns itself the first time slot/channel. If a response is received from other transceivers, the first transceiver assigns itself the next sequential time slot, e.g., after receiving responses from two transceivers; the first transceiver assigns itself to the third time slot. Transceivers are typically programmed to have 4-16, and preferably 8 broadcast time slots/channels as this is sufficient to provide broad coverage within the transmission range of two or more repeaters.

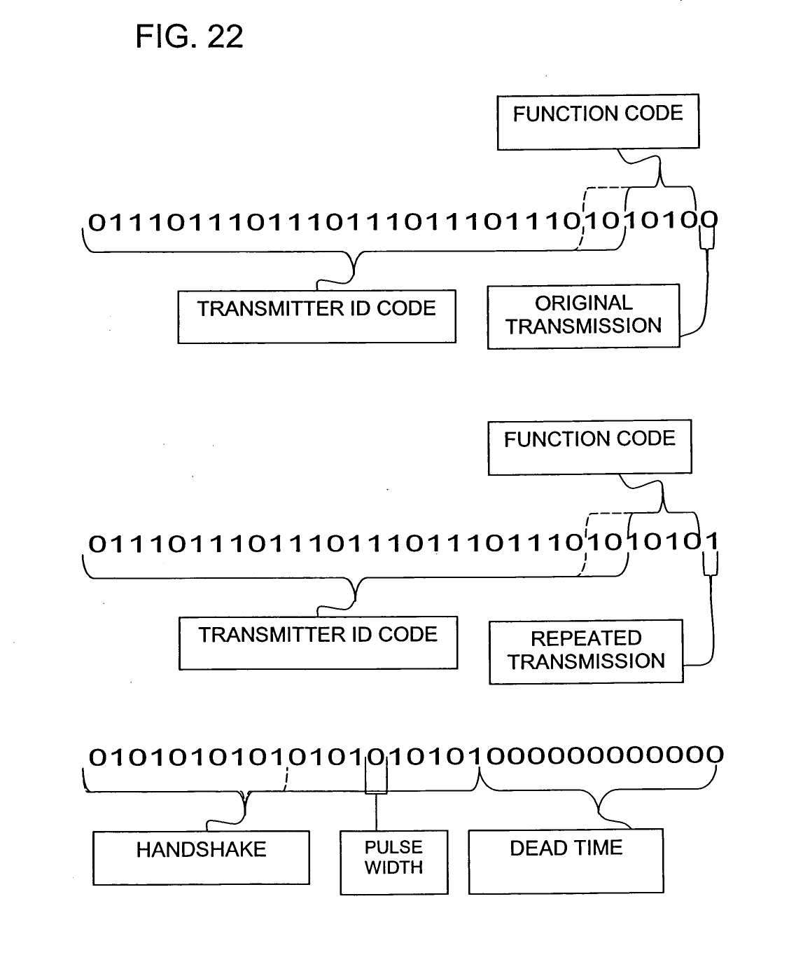

As mentioned above, the codes generated by the transmitter and accepted for performing an action at the receiver or transceiver (after a handshake) are preferably a 32-bit binary code comprising a unique (i.e., one of 2²⁴ to 2³⁰ combinations) transmitter identification code and a function code. As shown in FIG. 22, the transmitted code(s) from the transmitter comprise one or more unique identification code(s) having a length between 24 and 30 bits. The code generated by the transmitter also comprises a “function” code which corresponds to a mode of operation for a receiver. These function codes may be 1-6 bits in length and correspond to functions such as “TOGGLE”, “ON”, “OFF”, “50% ON”, “DIM”, “BRIGHTEN”, “STOP”, “SPEED UP”, “SLOW DOWN”, “LOCK”, “UNLOCK”, “ARM”, “DISARM”, “ACTIVATE”, “TEST”, “RESET”, “CANCEL” “TEMPERATURE=XX” and the like. The last digit of the 32-bit code is a “source” code indicating the source of the transmission. For example, a trailing 0 corresponds to a code originating from a transmitter, and a trailing 1 indicates a code repeated by a transceiver (alternately, a 0 could correspond to the transceiver and a 1 to the transmitter).

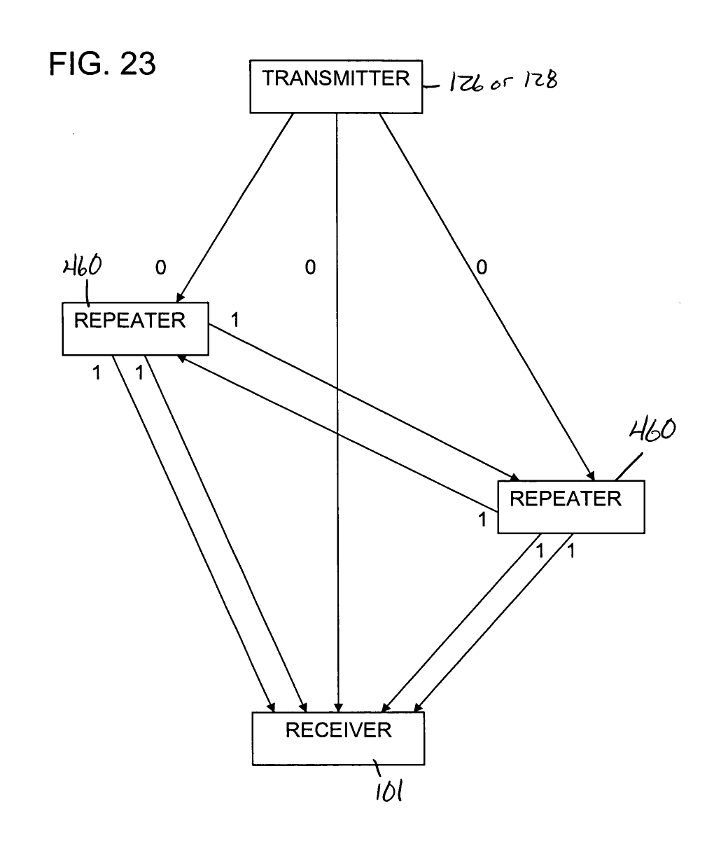

Referring again to FIGS. 15-16 and 22-23: The codes sent by the transmitter are modified and rebroadcast by one or more repeaters. The response action by the repeater depends on the nature of the received code. If a repeater receives a code having a trailing 0 corresponding to an original transmission from a transmitter, it will automatically repeat that code, with the exception that the repeater will change the trailing 0 to a trailing 1 in its retransmission, indicating it is a transmission originating from a repeater. If a repeater receives a code originating from another repeater, the repeater will repeat that code one time. The repeater is programmed to read the received identification code and retransmit it a maximum of two times (once for a received signal having a trailing 0 bit and once for a received signal having a trailing 1 bit). FIG. 23 is a schematic showing the transmission, repetition and reception between the transmitter, receiver and multiple repeaters.

The transmitters may be capable of developing one or more coded RF signals and the receivers likewise are capable of receiving one or more coded RF signals. The receivers have a memory therein for storing a number of codes, for example 5-50 code “slots”, and most preferably 30 codes. This permits the receivers to be “trainable” to accept coded RF signals from new or multiple transmitters and repeaters. The receiver is programmed to respond to codes from both transmitters and repeaters, and provide the same response action whether the trailing digit is a 0 from a transmitter or a trailing 1 from a repeater.

It is seen that the present invention allows a receiving system to respond to one of a plurality of transmitters which have different unique codes which can be stored in the receiver during a program mode. Each time the “program mode switch” 222 is moved to the program position, a different storage can be connected so that the new transmitter code would be stored in that address. After all of the address storage capacity has been used additional codes would erase an old code (i.e., FIFO) in the memory address storage before storing a new one.

Receivers are also programmed with a “dead time”, i.e., the repeater has a delay programmed into it so that it will only respond to one command within 1-2 seconds. This prevents the repeater from toggling multiple times in response to the reception of multiple transmitter and/or repeater codes within a certain time. Thus, if a receiver receives a code wherein the response is to toggle or change states, upon reception of that signal the receiver program initiates a delay period of 1-2 seconds wherein the receiver will not respond to any further received codes from transmitters or receivers.

A low voltage system extender 460 may also be used in conjunction with a low voltage receiver 600 as in FIG. 25. The low voltage system extender 460 may operate using the stepped down voltage from the transformer 650 used for the low voltage receiver 600, or the system extender 460 may have a separate low voltage source, such as from a separate transformer 650, or from a receiver power output port 685, or even low voltage batteries. The low voltage system extender 460 also has the same advantages as the low voltage receiver 600 in that it may be located anywhere in order to maximize system reception/retransmission as well as accessibility.

While in the preferred embodiment of the invention, the actuation means has been described as from mechanical to electric, it is within the scope of the invention to include batteries in the transmitter to power or supplement the power of the transmitter. For example, rechargeable batteries may be included in the transmitter circuitry and may be recharged through the electromechanical actuators. These rechargeable batteries may thus provide backup power to the transmitter.

This invention is safe because it eliminates the need for 120 VAC (220 VAC in Europe) lines to be run to each switch in the building. Instead the higher voltage overhead AC lines are only run to the appliances or lights, and they are actuated through the self-powered switching device and relay switch. The invention also saves on initial and renovation construction costs associated with cutting holes and running the electrical lines to/through each switch and within the walls. The invention is particularly useful in historic structures undergoing preservation, as the walls of the structure need not be destroyed and then rebuilt. The invention is also useful in concrete construction, such as structures using concrete slab and/or stucco construction and eliminate the need to have wiring on the surface of the walls and floors of these structures. Furthermore, the present invention has specific utility in commercial buildings where energy conservation has been mandated and energy savings (as well as government subsidies) can be realized, by allowing individual fixtures to have a 50% reduced lighting level. Further savings are realized because by having a low voltage power source available at every light fixture (through the transformer), other sensors and devices that use low voltage may be installed without having to have a dedicated or separate circuit for that device.

While the above description contains many specificities, these should not be construed as limitations on the scope of the invention, but rather as an exemplification of one preferred embodiment thereof. Many other variations are possible, for example:

In addition to piezoelectric devices, the electroactive elements may comprise magnetostrictive or ferroelectric devices;

Rather than being arcuate in shape, the actuators may normally be flat and still be deformable;

Multiple high deformation piezoelectric actuators may be placed, stacked and/or bonded on top of each other;

Multiple piezoelectric actuators may be placed adjacent each other to form an array.

Larger or different shapes of THUNDER elements may also be used to generate higher impulses.

The piezoelectric elements may be flextensional actuators or direct mode piezoelectric actuators.

Other means for applying pressure to the actuator may be used including simple application of manual pressure, rollers, pressure plates, toggles, hinges, knobs, sliders, twisting mechanisms, release latches, spring loaded devices, foot pedals, game consoles, traffic activation and seat activated devices.

AC or DC power sources may be used rather than a deflected electroactive generator to power transmitters that communicate with the receivers and repeaters in the system.

We claim:

1. A self-powered wireless switching system comprising:
an electromechanical generator for generating a voltage across first and second electrical terminals;
a voltage regulator having an input side and an output side; said input side of said voltage regulator being electrically connected to said first and second electrical terminals;
first signal transmission means electrically connected to said output side of said voltage regulator;
said first signal transmission means comprising a first encoder having an input side and an output side; and
a first electromagnetic signal generator connected to an antenna;
said input side of said first encoder being connected to said output side of said voltage regulator;
said output side of said first encoder being connected to said first electromagnetic signal generator;
wherein said first encoder circuit is programmable to generate one or more unique codes;
and wherein each of said unique codes generated by said first encoder circuit is different from each of said unique codes generated all other encoder circuits;
and wherein said first signal transmission means is adapted to transmit a first electromagnetic signal modulated by said one of said one or more unique codes;
signal reception means for receiving said or second first electromagnetic signal;
said signal reception means being adapted to generate a low DC voltage control signal at an output of said signal reception means in response to said first or second electromagnetic signal;
said signal reception means having a low DC voltage power input;
a transformer having an input and an output;
said input of said transformer being connected to an AC voltage or a DC voltage exceeding 60 VDC;
said output of said transformer having DC voltage under 60 VDC;
said low DC voltage power input of said signal reception means being electrically connected to said output of said transformer; and
a switch having a first position and a second position; said switch being in electrical communication with said output of said signal reception means;
said switch being adapted to change between said first position and said second position in response to said low DC voltage control signal.
